(19) United States
(12) Patent Application Publication
(10) Pub. No.: US 2004/0007402 A1
(43) Pub. Date: Jan. 15, 2004

(54) Multipurpose power transferring device and working attachments

(76) Inventor: Roger D. Kujawa, Morton, IL (US)

Correspondence Address: HUSCH & EPPENBERGER, LLC, 401 MAIN STREET, SUITE 1400, PEORIA, IL, 61602, US

(21) Appl. No.: 10/455,485

(22) Filed: Jun. 5, 2003

Related U.S. Application Data
(60) Provisional application No. 60/391,766, filed on Jun. 26, 2002.

(51) Int. Cl. B60K 17/28

(52) U.S. Cl. 180/53.8

(57) ABSTRACT

A powering device or power transferring device having an engine, frame, handle arms, first and second handles, wheels, support member, control panel, safety shutoff handle, power shaft and coupling for transferring power to various working attachments.

### CROSS REFERENCE TO RELATED APPLICATIONS

This application claims priority of Provisional Application No. 60/391,766 filed in the United States of America on Jun. 26, 2002.

### TECHNICAL FIELD OF THE INVENTION

This invention generally relates to a device for transferring power to working units and, more particularly, to a multipurpose powering device or power transferring device for powering interchangeable working attachments.

### DESCRIPTION OF THE RELATED ART

Traditionally, homeowners care for and maintain their property with various powered machines. For example, homeowners use soil tillers to prepare, soil aerators to treat, spreaders to fertilize, lawnmowers to manicure and edgers to define the edges of their lawns during the growing season. During the winter season, homeowners use snow blowers for the removal of snow. In addition, some homeowners have powered pumps, sweepers, outdoor vacuums, trenchers, limb chippers and mulchers, dump hopper/soil sieves, brush trimmers, sod rollers, haulers/dumpers, pavement cutters, power washers and generators, to name a few.

The storage area required to store these devices is enormous and impractical. Typically, homeowners sacrifice a garage stall for storing these devices. Alternatively or in addition to using the garage stall, homeowners purchase or build sheds to accommodate these devices.

Significantly, there are safety concerns with storing multiple powered machines in confined places. Fuel vaporizes and produces an odor, and the vaporizing is increased in warmer temperatures. The vaporizing of fuel produces an odor that is unpleasant and excessive exposure can result in dizziness, loss of consciousness and other health related problems.

Proper maintenance prolongs the life of powered machines, and the warranties protecting these powered machines are void for lack of proper maintenance. The costs and time involved with maintaining multiple powered machines are enormous.

Providing a powering device or power transferring device to power multiple interchangeable working attachments is desirable to reduce storage requirements, the number of powered machines needed to perform various tasks and maintenance costs and time. However, no such suitable device has been available to date.

The present invention is directed to overcoming one or more of the problems and disadvantages set forth above.

### SUMMARY OF THE INVENTION

An aspect of the present invention is to provide a device for overcoming one or more of the problems and disadvantages set forth above.

In another aspect of the present invention there is provided a powering device or power transferring machine capable of powering various interchangeable working attachments.

These aspects are merely an illustrative aspect of the innumerable aspects associated with the present invention and should not be deemed as limiting in any manner. These and other aspects, features and advantages of the present invention will become apparent from the following detailed description when taken in conjunction with the referenced drawings.

### BRIEF DESCRIPTION OF THE DRAWINGS

Reference is now made more particularly to the drawings, which illustrate the best presently known mode of carrying out the invention and wherein similar reference characters indicate the same parts throughout the views.

FIG. 1 is a side view of a powering device for powering various interchangeable working attachments;

FIG. 2 is a side view of a powering device for powering various interchangeable working attachments in a vertical storage position;

FIG. 3 is a top view of a powering device for powering various interchangeable working attachments;

FIG. 4 is a top view of a powering shaft from an engine of the powering device and an attachment shaft from various interchangeable working attachments;

FIG. 5 is a is a side view of a powering device shaft from an engine of the powering device and an attachment shaft from various interchangeable working attachments;

FIG. 6 is an end view of a powering device shaft from an engine of the powering device and an attachment shaft from various interchangeable working attachments;

FIGS. 7A and 7B are side views of the powering device attached to each of the interchangeable working attachments;

FIG. 8 is a side view of the powering device attached to the interchangeable working attachment called a snow blower;

FIG. 9 is a side view of the powering device attached to the interchangeable working attachment called a snow blower;

FIG. 10 is a top view of the powering device attached to the interchangeable attachments called the snow blower, lawn dethatcher power rake, edger, soil aerator, sod cutter, pavement cutter, soil tiller and trencher;

FIG. 11 is a side view of the power takeoff device attached to the interchangeable attachment called the lawn dethatcher power rake;

FIG. 12 is a side view of the power takeoff device attached to the interchangeable attachment called the lawn dethatcher power rake;

FIG. 13 is a side view of the powering device attached to the interchangeable attachment called the edger;

FIG. 14 is a side view of the powering device attached to the interchangeable attachment called the edger;

FIG. 15 is a side view of the powering device attached to the interchangeable attachment called the soil aerator;

FIG. 16 is a side view of the powering device attached to the interchangeable attachment called the soil aerator;

FIG. 17 is a side view of the powering device attached to the interchangeable attachment called the sod cutter;

FIG. 18 is a side view of the powering device attached to the interchangeable attachment called the sod cutter;

FIG. 19 is a side view of the powering device attached to the interchangeable attachment called the pavement cutter;

FIG. 20 is a side view of the powering device attached to the interchangeable attachment called the pavement cutter;

FIG. 21 is a side view of the powering device attached to the interchangeable attachment called the soil tiller;

FIG. 22 is a side view of the powering device attached to the interchangeable attachment called the soil tiller;

FIG. 23 is a top view of the powering device attached to the interchangeable attachments called the pump, power washer, generator, chipper, lift and air compressor;

FIG. 24 is a side view of the powering device attached to the interchangeable attachment called the pump;

FIG. 25 is a side view of the powering device attached to the interchangeable attachment called the pump;

FIG. 26 is a side view of the powering device attached to the interchangeable attachment called the power washer/garden sprayer;

FIG. 27 is a side view of the powering device attached to the interchangeable attachment called the power washer/garden sprayer;

FIG. 28 is a side view of the powering device attached to the interchangeable attachment called the generator;

FIG. 29 is a side view of the powering device attached to the interchangeable attachment called the generator;

FIG. 30 is a side view of the powering device attached to the interchangeable attachment called the limb chipper/mulcher;

FIG. 31 is a side view of the powering device attached to the interchangeable attachment called the limb chipper/mulcher;

FIG. 32 is a side view of the powering device attached to the interchangeable attachment called the fork lift/garbage can holder;

FIG. 33 is a side view of the powering device attached to the interchangeable attachment called the fork lift/garbage can holder;

FIG. 34 is a top view of the powering device attached to the interchangeable attachments called the sweeper/vacuum, grass mower and the brush trimmer;

FIG. 35 is a side view of the powering device attached to the interchangeable attachment called the grass mower;

FIG. 36 is a side view of the powering device attached to the interchangeable attachment called the grass mower;

FIG. 37 is a side view of the powering device attached to the interchangeable attachment called the brush trimmer;

FIG. 38 is a side view of the powering device attached to the interchangeable attachment called the brush trimmer;

FIG. 39 is a side view of the powering device attached to the interchangeable attachment called the sweeper/vacuum;

FIG. 40 is a side view of the powering device attached to the interchangeable attachment called the sweeper/vacuum;

FIG. 41 is a side view of the powering device attached to the interchangeable attachment called the trencher;

FIG. 42 is a side view of the powering device attached to the interchangeable attachment called the trencher;

FIG. 43 is a top view of the powering device attached to the interchangeable attachments called the dump hopper/soil sieve, sod roller, blade/plow and spreader;

FIG. 44 is a side view of the powering device attached to the interchangeable attachment called the dump hopper/soil sieve;

FIG. 45 is a side view of the powering device attached to the interchangeable attachment called the dump hopper/soil sieve;

FIG. 46 is a side view of the powering device attached to the interchangeable attachment called the sod roller;

FIG. 47 is a side view of the powering device attached to the interchangeable attachment called the sod roller;

FIG. 48 is a side view of the powering device attached to the interchangeable attachment called the blade/plow;

FIG. 49 is a side view of the powering device attached to the interchangeable attachment called the blade/plow;

FIG. 50 is a side view of the powering device attached to the interchangeable attachment called the spreader;

FIG. 51 is a side view of the powering device attached to the interchangeable attachment called the spreader;

FIG. 52 is a side view of the powering device attached to the interchangeable attachment called the air compressor; and

FIG. 53 is a side view of the powering device attached to the interchangeable attachment called the air compressor; and

FIG. 54 is a side view of a hinge clamp and clamp receiver.

### DETAILED DESCRIPTION

In the following detailed description numerous specific details are set forth in order to provide a thorough understanding of the invention. However, it will be understood by those skilled in the art that the present invention may be practiced without these specific details. For example, the invention is not limited in scope to the particular type of industry application depicted in the figures. In other instances, well-known methods, procedures, and components have not been described in detail so as not to obscure the present invention.

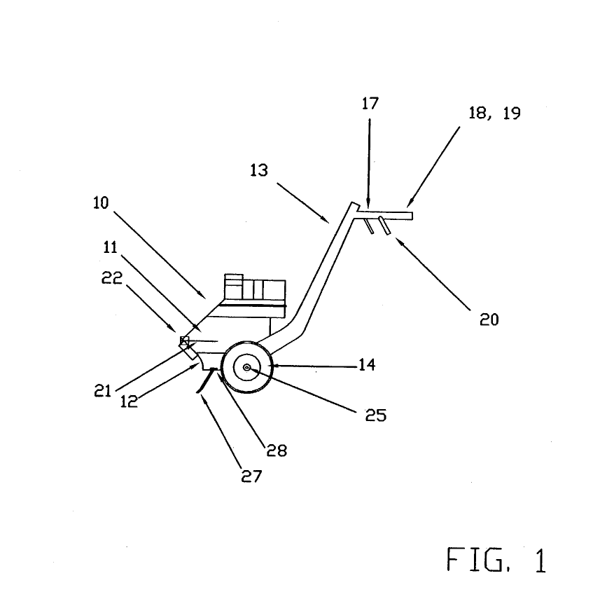

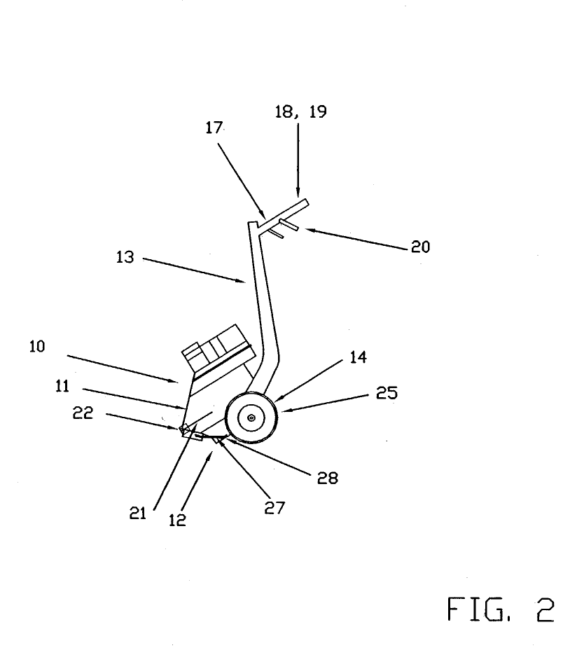

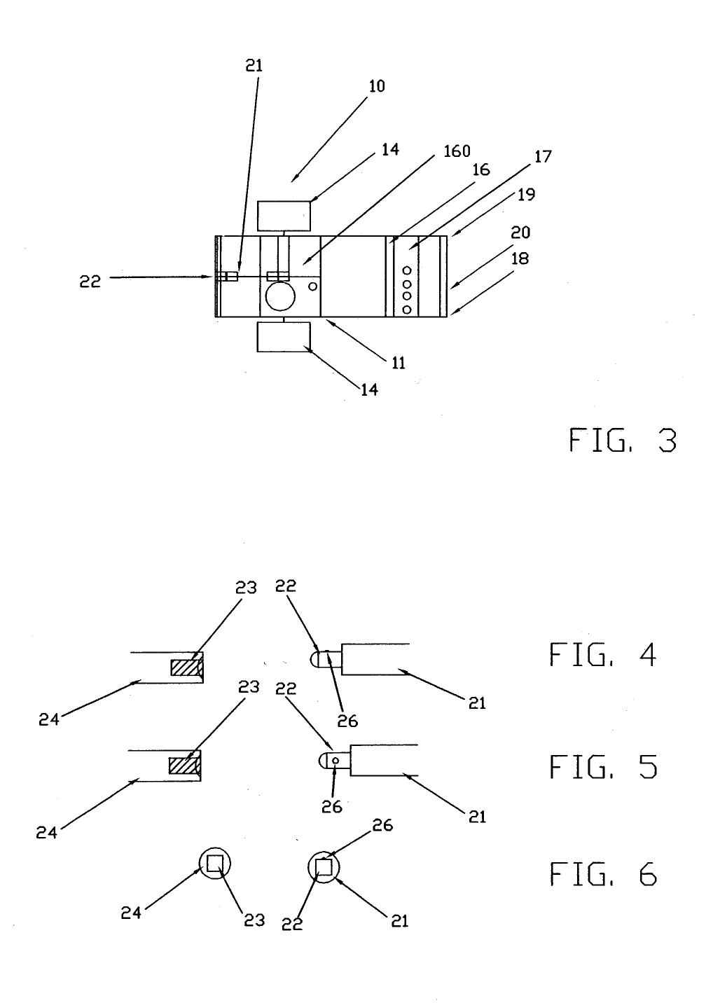

Referring now to the drawings, FIGS. 1, 2 & 3 illustrate a powering device or power transferring device 10 for powering working attachments. The powering device 10 has an engine 11. The engine 11 is best selected from a horsepower range from four to seven horsepower; however, the engine 11 is preferable six horsepower. The engine 11 is typical of those used on snow blowers and lawnmowers. The engine 11 is mounted on a frame 12. In the operating position which is shown in FIG. 1, the frame 12 is approximately parallel to the ground; however, the position of the frame 12 with respect to the ground is dependent upon the slope of the terrain. Wheels 14 are rotatably mounted to the frame 12, and the wheels 14 are used for moving the powering device 10. The frame 12 is connected to handle arms 13. The handle arms 13 have a first handle 18 and a second handle 19, and a support member 16 is operatively attached between the first handle 18 and the second handle 19. A control panel 17 is operatively attached to the support member 16. A center of gravity of the powering device 10 is forward the axis of the wheels 25 in a direction away from the handles 18, 19. To support the powering device 10 in a position according to FIG. 1 or with the frame 12 approximately parallel to the ground, a kickstand 27 is operatively attached to the frame 12. The kickstand 27 is pivotable about a kickstand axle 28. The kickstand 27 can be similar to bicycle kickstands.

Controls for turning the engine 11 on and off, operating the speed of the engine 11, operating the rotation of the wheels 14, braking the wheels 14 and other functions are operatively attached to the control panel 17. The controls operate substantially similar to the controls on lawn mowers and snow blowers. A safety shutoff 20 is also provided proximate to the control panel 17. The safety shutoff handle 20 turns the engine 11 off in the event the user releases the safety shutoff handle 20. When the shut off handle 20 is held in an “on” or up position, the engine 11 is able to operate; however, when the shut off handle 20 is released, it is forced into an “off” or downward position via a spring, thereby shutting off the engine 11. The safety shutoff handle 20 and its operation are well known in the art.

The user applies manual forward force to the handles 18, 19 to move the powering device 10. In alternative embodiments, the engine 11 powers the wheels 14. For example, the engine 11 is connected to a wheel transmission 160 for rotating the wheels 14. The wheel transmission 160 is capable of rotating the wheels 14 at various speeds, and a wheel speed control on the control panel 17 is used for this purpose. In addition, a wheel control on the control panel 17 controls the rotation of the wheels 17. For example, the wheel control provides a forward, neutral and backward movement to the wheels 17. The wheel speed and the wheel control are separate controls in the preferred embodiment, and single or two separate transmissions can be used for this arrangement. There is also a powering device transmission 161. The wheel transmission 160 and the powering device transmission 161 provide independent speed controls to the wheels 14 and the interchangeable working attachments, respectively.

The engine 11 is, preferably, gas or gas/oil powered; however, an electric engine can be substituted. The engine 11 is started by either a pull start or an electric starter connected to a battery. These starting devices are well known in the art.

The engine 11 supplies rotational movement to a power shaft 21. The power shaft 21 has a connector 22 for connecting to the interchangeable working attachments. The power shaft 21 and the connector 22 are forward the center gravity of the powering device 10 in the direction away from the handles 18, 19. The working attachments have a mating connector 23 for connecting to the connector 22 of the power shaft 21. The mating connector 23 has an attachment shaft 24 for transferring the rotational movement from the power shaft 21 and the connector 22 of the powering device 10 to the interchangeable working attachments. In the preferred embodiment, the connector 22 of the power shaft 21 and the mating connector 23 of the attachment shaft 24 are similar to a ¾^{th} inch socket drive set. FIGS. 4-6 illustrate the power shaft 21, the coupling 22, the mating connector 23 and the attachment shaft 24 as the ¾^{th} inch socket drive set. In this embodiment, the coupling 22 on the power shaft 21 has a spring-loaded ball bearing 26 for maintaining a snug connection with the mating connector 23 of the attachment shaft 24. It is important to note that the ¾^{th} inch socket drive set embodiment is only one of many transferring connections that can be utilized.

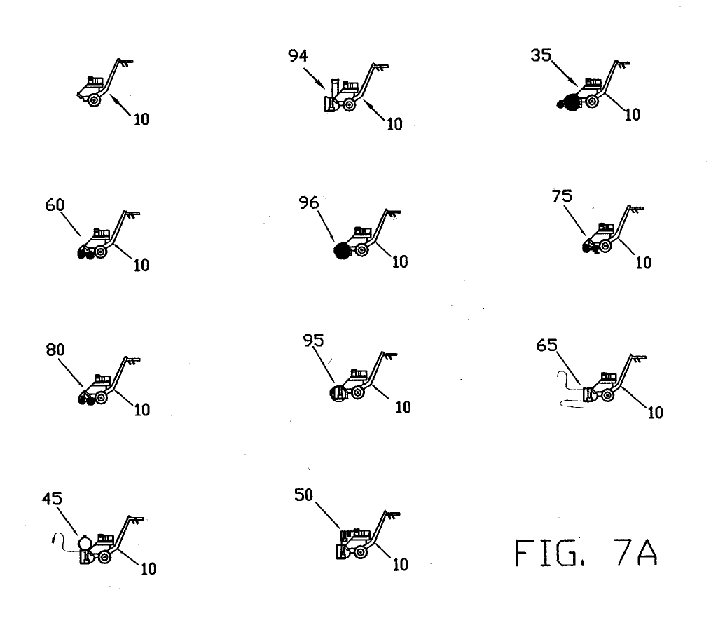

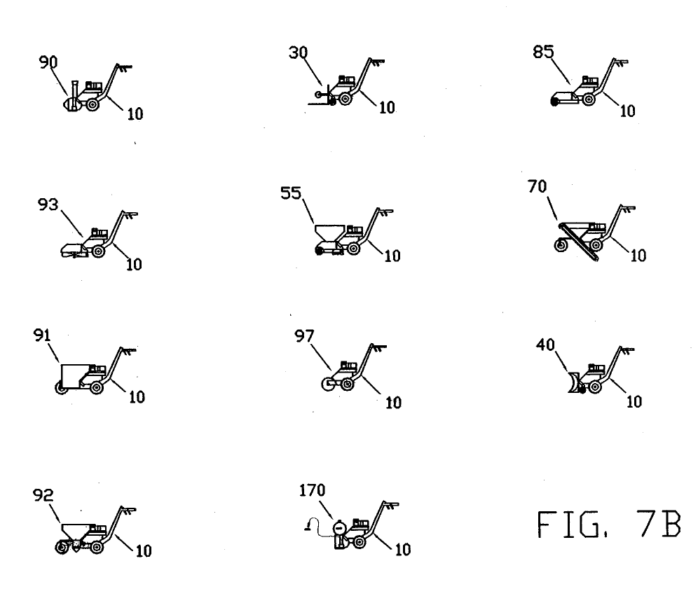

FIGS. 7A and 7B show each of the interchangeable working attachments. The interchangeable working attachments include, but are not limited to, a fork lift garbage can mover 30, lawn dethatcher power rake 35, blade 40, power washer garden sprayer 45, generator 50, sweeper/vacuum 55, edger 60, pump 65, trencher 70, sod cutter 75, pavement cutter 80, grass mower 85, limb chipper mulcher 90, dump hopper soil sieve 91, spreader 92, brush trimmer 93, snow blower 94, soil tiller 95, soil aerator 96, sod roller 97 and air compressor 170. Each of these interchangeable working attachments connect to the powering device 10. Specifically, the powering device 10 powers the power shaft 21 and the power shaft 21 has the coupling 22 which operatively connects to the mating connector 23 of the attachment shaft 24 of the interchangeable working attachments.

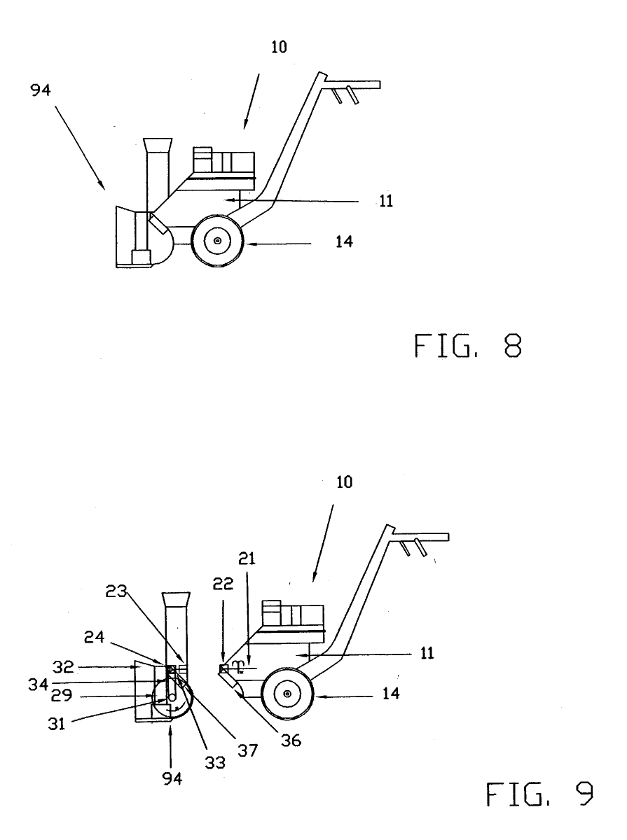

FIGS. 8-10 show the powering device 10 attached to the interchangeable working attachment called the snow blower 94. The snow blower 94 is operatively connected to the powering device 10. Specifically, the coupling 22 of the power shaft 21 is rotatably connected to the mating connector 23 of the attachment shaft 24 of the snow blower 94. The rotational directions of the power shaft 21 and the attachment shaft 24 are shown as x. Because the rotational direction x needs to be transferred 90 degrees to rotate blades 29 around a snow blower axle 31 as shown by rotational direction y, a power transfer unit 32 is operatively connected between the attachment shaft 24 and snow blower axle 31. The snow blower axle 31 is rotatably attached to a snow blower hood 68. The power transfer unit 32 transfers the rotational movement x by 90 degrees to rotational movement y. The power transfer unit 32 is preferably the belts or chain 34 encompassing pulley or gears 33, respectively, and the snow blower axle 31. An alternative embodiment includes a gearbox for transferring rotational movement x 90 degrees to rotational movement y.

The powering device 10 has a driving connection to, for example, the snow blower 94 via a power take off. This driving connection includes male connectors 22 and female receiver connectors 23. FIGS. 4-6 show one type of male connectors 22 and female receiver connectors 23. There are various types of connectors, known to those skilled in the art, that could be substituted for the male and female receiver connectors to transfer the power.

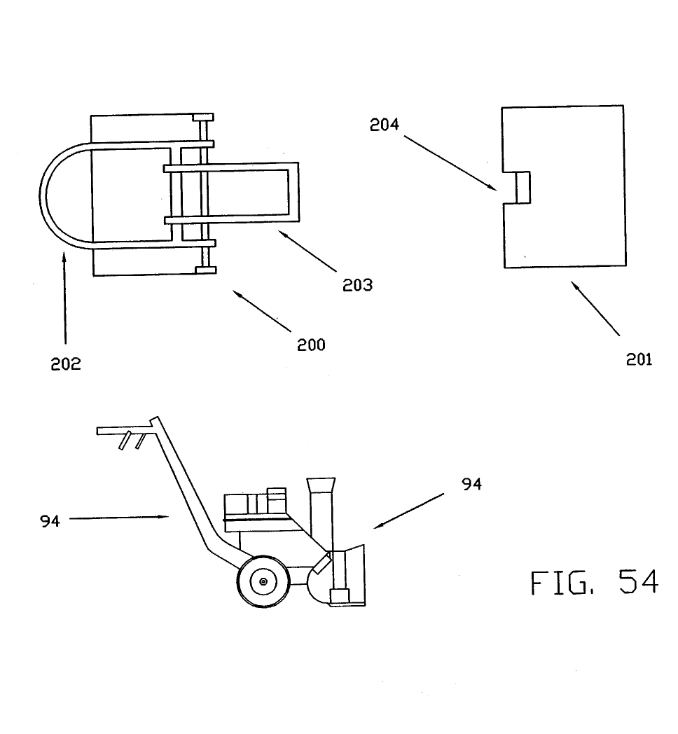

In one alternative embodiment shown in FIG. 54, the powering device 10 is secured to the snow blower 94 via a hinge clamp 200 and clamp receiver 201. Together these hold the units together. The hinge clamp 200 has a handle 202 and locking mechanism 203. The clamp receiver 201 has a receiver 204. To lock the hinge clamp 200 to the clamp receiver 201, the handle 202 is moved all the way to the right so that the locking mechanism 203 engages the receiver 204. Thereafter, the handle 202 is moved all the way to the left thereby locking the hinge clamp 200 to the clamp receiver 201. The hinge clamp 200 and the clamp receiver 201 are used to fasten the powering device 10 to any one of the working attachments. Other attachments, hereinafter described, may be held via similar parts 200 and 201.

When the engine 11 of the powering device 10 is started, the user can cause the power shaft 21 to rotate via the controls on the control panel 17. The rotational movement x of the power shaft 21 is transferred to the attachment shaft 24. The power transfer unit 32 transfers the rotational movement x by 90 degrees to rotational movement y, thereby rotating the blades 40 about the snow blower axle 31. In addition, the powering device 10 is capable of power the wheels 14.

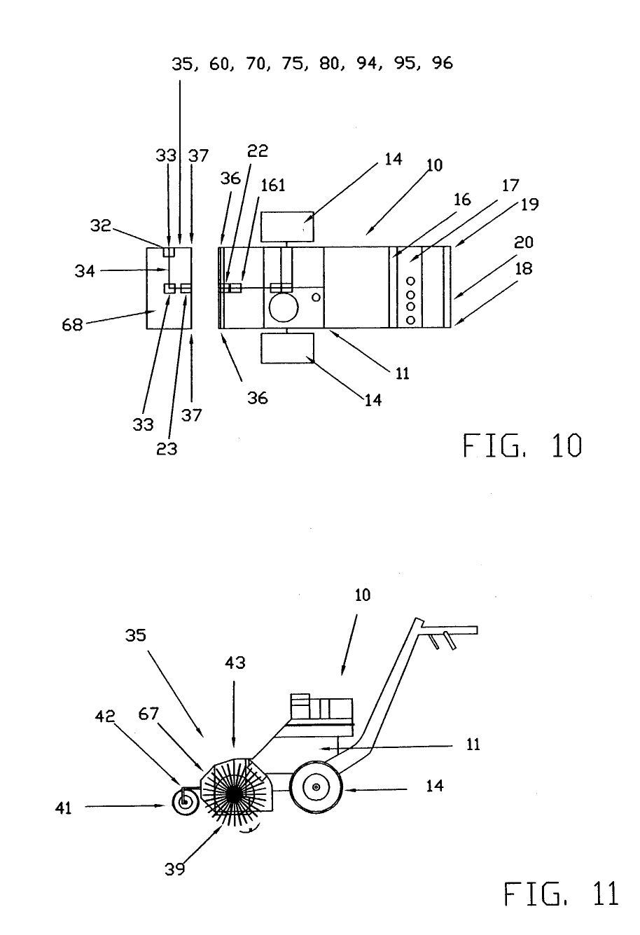

FIGS. 10-12 show the powering device 10 attached to the interchangeable working attachment called the lawn dethatcher power rake 35. The lawn dethatcher power rake 35 is operatively connected to the powering device 10. Specifically, the coupling 22 of the power shaft 21 is rotatably connected to the mating connector 23 of the attachment shaft 24 of the lawn dethatcher power rake 35. The rotational directions of the power shaft 21 and the attachment shaft 24 are shown as x. Because the rotational direction x needs to be transferred 90 degrees to rotate rakes 39 around a dethatcher power rake axle 38 as shown by rotational direction y, the power transfer unit 32 is operatively connected between the attachment shaft 24 and the dethatcher power rake axle 38. The dethatcher power rake axle 38 is rotatably attached to a dethatcher hood 67. The power transfer unit 32 transfers the rotational movement x by 90 degrees to rotational movement y. The power transfer unit 32 is preferably the belts or chain 34 encompassing pulley or gears 33, respectively, and the dethatcher power rake axle 38. An alternative embodiment includes a gearbox for transferring rotational movement x 90 degrees to rotational movement y.

The powering device 10 is secured to the lawn dethatcher power rake 35 via the male connectors 22 and the female receiver connectors 23. FIGS. 4-6 show one type of the male connectors 22 and the female receiver connectors 23. There are various types of fasteners, known to those skilled in the art, that could be substituted for the male connectors 22 and the female receiver connectors 23. For example in one alternative embodiment shown in FIG. 54, the powering device 10 is secured to the lawn power rake 35 via a hinge clamp 200 and clamp receiver 201. The hinge clamp 200 has a handle 202 and locking mechanism 203. The clamp receiver 201 has a receiver 204. To lock the hinge clamp 200 to the clamp receiver 201, the handle 202 is moved all the way to the right so that the locking mechanism 203 engages the receiver 204. Thereafter, the handle 202 is moved all the way to the left thereby locking the hinge clamp 200 to the clamp receiver 201. The hinge clamp 200 and the clamp receiver 201 are used to fasten the powering device 10 to any one of the working attachments.

To support the lawn dethatcher power rake 35, rake wheels 41 are rotatably connected to brackets 42 via dethatcher power rake wheel axles 126. The brackets 42 are connected to a rake hood 43.

When the engine 11 of the powering device 10 is started, the user can cause the power shaft 21 to rotate via the controls on the control panel 17. The rotational movement x of the power shaft 21 is transferred to the attachment shaft 24. The power transfer unit 32 transfers the rotational movement x by 90 degrees to rotational movement y, thereby rotating the rakes 39 about the dethatcher power rake axle 38. In addition, the powering device 10 is capable of powering the wheels 14.

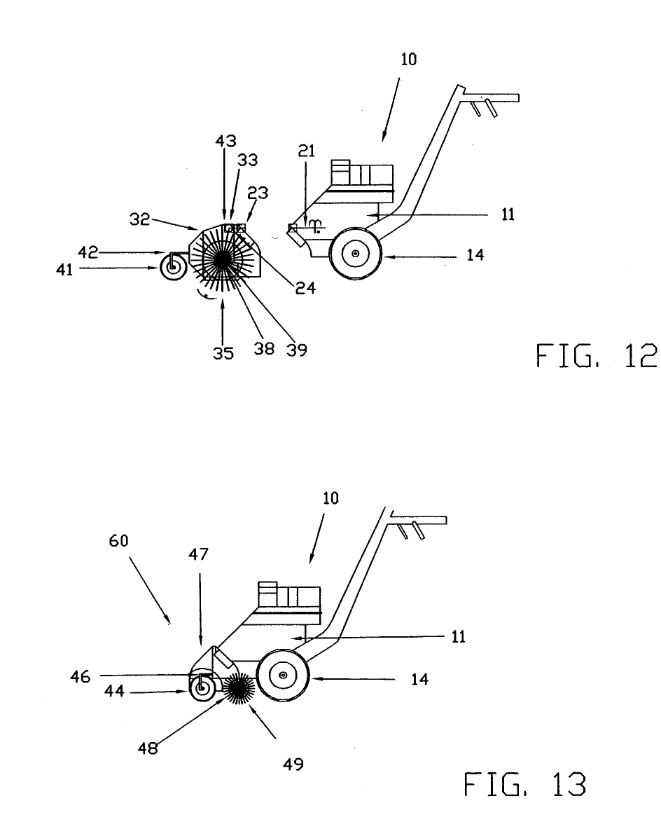

FIGS. 10, 13 and 14 show the powering device 10 attached to the interchangeable working attachment called the edger 60. The edger 60 is operatively connected to the powering device 10. Specifically, the coupling 22 of the power shaft 21 is rotatably connected to the mating connector 23 of the attachment shaft 24 of the edger 60. The rotational directions of the power shaft 21 and the attachment shaft 24 are shown as x. Because the rotational direction x needs to be transferred 90 degrees to rotate edger tools 49 around an edger axle 48 as shown by rotational direction y, the power transfer unit 32 is operatively connected between the attachment shaft 24 and the edger axle 48. The edger axle 48 is rotatably attached to an edger hood 47. The power transfer unit 32 transfers the rotational movement x by 90 degrees to rotational movement y. The power transfer unit 32 is preferably the belts or chain 34 encompassing pulley or gears 33, respectively, and the edger axle 48. An alternative embodiment includes a gearbox for transferring rotational movement x 90 degrees to rotational movement

The powering device 10 has a driving connection to, for example, the edger 60 via a power take off. This driving connection includes male connectors 22 and 30 female receiver connectors 23. FIGS. 4-6 show one type of male connectors 22 and female receiver connectors 23. There are various types of connectors, known to those skilled in the art, that could be substituted for the male and female receiver connectors to transfer the power.

To support the edger 60, edger wheels 44 are rotatably connected to edger brackets 46 via edger wheel axles 127. The edger brackets 46 are connected to an edger hood 47.

When the engine 11 of the powering device 10 is started, the user can cause the power shaft 21 to rotate via the controls on the control panel 17. The rotational movement x of the power shaft 21 is transferred to the attachment shaft 24. The power transfer unit 32 transfers the rotational movement x by 90 degrees to rotational movement y, thereby rotating the edger tools 49 about the edger axle 48. In addition, the powering device 10 is capable of powering the wheels 14.

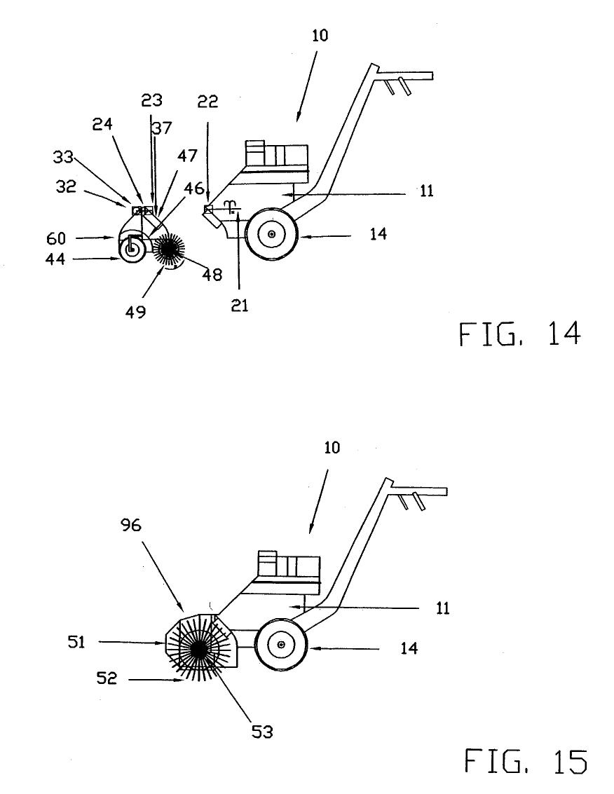

FIGS. 10, 15 and 16 show the powering device 10 attached to the interchangeable working attachment called the soil aerator 96. The soil aerator 96 is operatively connected to the powering device 10. Specifically, the coupling 22 of the power shaft 21 is rotatably connected to the mating connector 23 of the attachment shaft 24 of the soil aerator 96. The rotational directions of the power shaft 21 and the attachment shaft 24 are shown as x. Because the rotational direction x needs to be transferred 90 degrees to rotate aerator tools 52 around an aerator axle 53 as shown by rotational direction y, the power transfer unit 32 is operatively connected between the attachment shaft 24 and the aerator axle 53. The soil aerator axle 53 is rotatably attached to an aerator hood 51. The power transfer unit 32 transfers the rotational movement x by 90 degrees to rotational movement y. The power transfer unit 32 is preferably the belts or chain 34 encompassing pulley or gears 33, respectively, and the aerator axle 53. An alternative embodiment includes a gearbox for transferring rotational movement x 90 degrees to rotational movement y.

The powering device 10 has a driving connection to, for example, the soil aerator 96 via a power take off. This driving connection includes male connectors 22 and female receiver connectors 23. FIGS. 4-6 show one type of male connectors 22 and female receiver connectors 23. There are various types of connectors, known to those skilled in the art, that could be substituted for the male and female receiver connectors to transfer the power.

When the engine 11 of the powering device 10 is started, the user can cause the power shaft 21 to rotate via the controls on the control panel 17. The rotational movement x of the power shaft 21 is transferred to the attachment shaft 24. The power transfer unit 32 transfers the rotational movement x by 90 degrees to rotational movement y, thereby rotating the aerator tools 52 about the aerator axle 48. In addition, the powering device 10 is capable of powering the wheels 14.

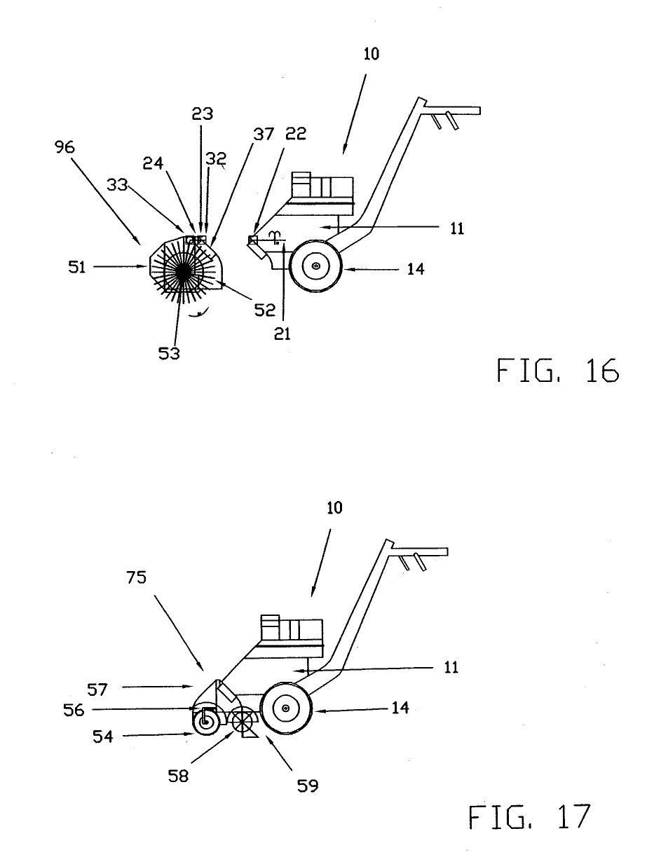

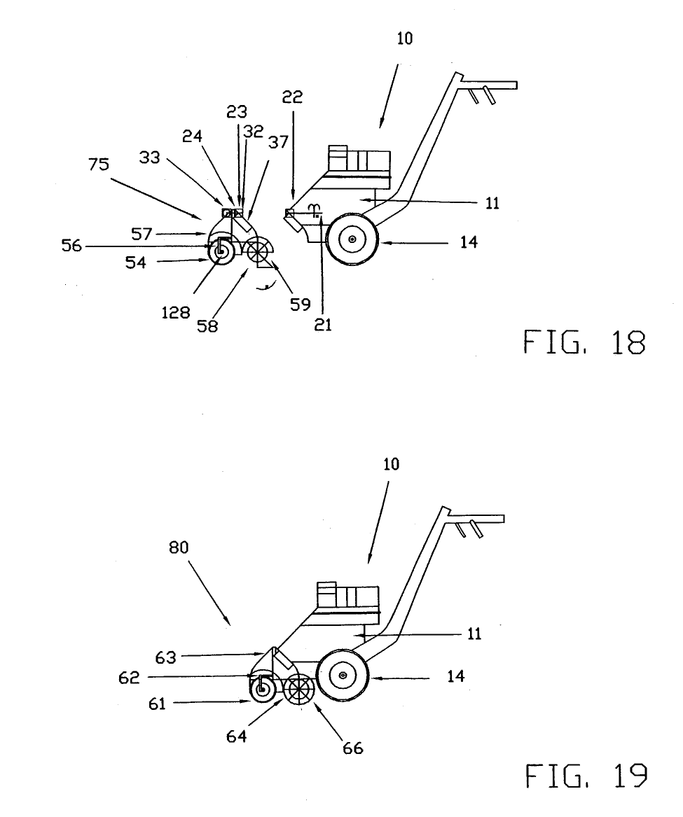

FIGS. 10, 17 and 18 show the powering device 10 attached to the interchangeable working attachment called the sod cutter 75. The sod cutter 75 is operatively connected to the powering device 10. Specifically, the coupling 22 of the power shaft 21 is rotatably connected to the mating connector 23 of the attachment shaft 24 of the sod cutter 75. The rotational directions of the power shaft 21 and the attachment shaft 24 are shown as x. Because the rotational direction x needs to be transferred 90 degrees to rotate sod cutter tools 59 around a sod cutter axle 58 as shown by rotational direction y, the power transfer unit 32 is operatively connected between the attachment shaft 24 and the sod cutter axle 58. The sod cutter axle 58 is rotatably attached to a sod cutter hood 57. The power transfer unit 32 transfers the rotational movement x by 90 degrees to rotational movement y. The power transfer unit 32 is preferably the belts or chain 34 encompassing pulley or gears 33, respectively, and the sod cutter axle 58. An alternative embodiment includes a gearbox for transferring rotational movement x 90 degrees to rotational movement y.

To support the sod cutter 75, sod cutter wheels 54 are rotatably connected to sod cutter brackets 56 via sod cutter wheel axles 128. The sod cutter brackets 56 are connected to the sod cutter hood 57.

When the engine 11 of the powering device 10 is started, the user can cause the power shaft 21 to rotate via the controls on the control panel 17. The rotational movement x of the power shaft 21 is transferred to the attachment shaft 24. The power transfer unit 32 transfers the rotational movement x by 90 degrees to rotational movement y, thereby rotating the sod cutter tools 58 about the sod cutter axle 58. In addition, the powering device 10 is capable of powering the wheels 14.

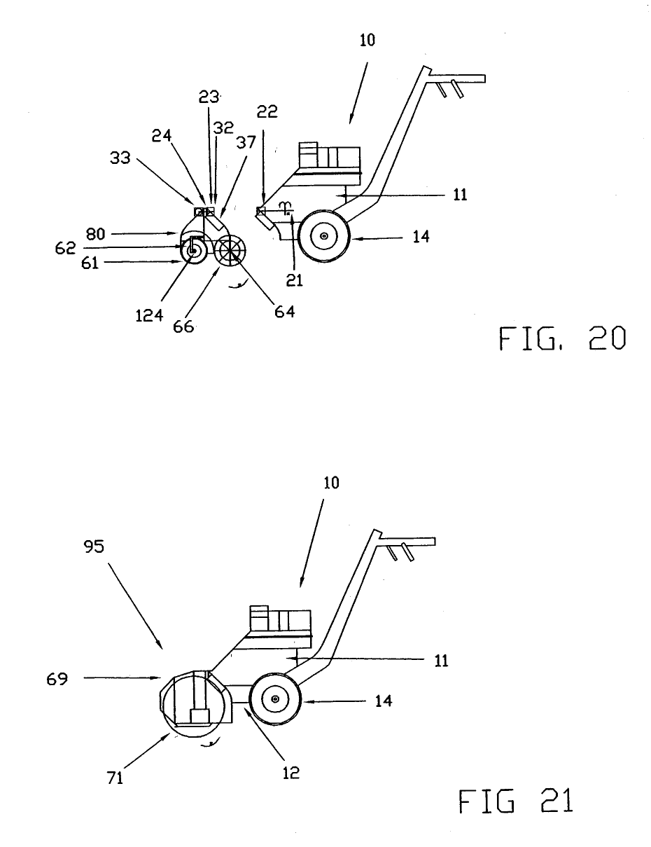

FIGS. 10, 19 and 20 show the powering device 10 attached to the interchangeable working attachment called the pavement cutter 80. The pavement cutter 80 is operatively connected to the powering device 10. Specifically, the coupling 22 of the power shaft 21 is rotatably connected to the mating connector 23 of the attachment shaft 24 of the pavement cutter 80. The rotational directions of the power shaft 21 and the attachment shaft 24 are shown as x. Because the rotational direction x needs to be transferred 90 degrees to rotate pavement cutter tools 66 around a pavement cutter axle 64 as shown by rotational direction y, the power transfer unit 32 is operatively connected between the attachment shaft 24 and the pavement cutter axle 64. The pavement cutter axle 64 is rotatably attached to a pavement cutter hood 63. The power transfer unit 32 transfers the rotational movement x by 90 degrees to rotational movement y. The power transfer unit 32 is preferably the belts or chain 34 encompassing pulley or gears 33, respectively, and the pavement cutter axle 64. An alternative embodiment includes a gearbox for transferring rotational movement x 90 degrees to rotational movement y.

To support the pavement cutter 80, pavement cutter wheels 61 are rotatably connected to pavement cutter brackets 62 via pavement cutter wheel axles 124. The pavement cutter brackets 62 are connected to the pavement cutter hood 63.

When the engine 11 of the powering device 10 is started, the user can cause the power shaft 21 to rotate via the controls on the control panel 17. The rotational movement x of the power shaft 21 is transferred to the attachment shaft 24. The power transfer unit 32 transfers the rotational movement x by 90 degrees to rotational movement y, thereby rotating the pavement cutter tools 66 about the pavement cutter axle 64. In addition, the powering device 10 is capable of powering the wheels 14.

FIGS. 10, 21 and 22 show the powering device 10 attached to the interchangeable working attachment called the soil tiller 95. The soil tiller 95 is operatively connected to the powering device 10. Specifically, the coupling 22 of the power shaft 21 is rotatably connected to the mating connector 23 of the attachment shaft 24 of the soil tiller 95. The rotational directions of the power shaft 21 and the attachment shaft 24 are shown as x. Because the rotational direction x needs to be transferred 90 degrees to rotate soil tiller blades 71 around a soil tiller axle 72 as shown by rotational direction y, the power transfer unit 32 is operatively connected between the attachment shaft 24 and the soil tiller axle 72. The soil tiller axle 72 is rotatably attached to a soil tiller hood 69. The power transfer unit 32 transfers the rotational movement x by 90 degrees to rotational movement y. The power transfer unit 32 is preferably the belts or chain 34 encompassing pulley or gears 33, respectively, and the pavement cutter axle 64. An alternative embodiment includes a gearbox for transferring rotational movement x 90 degrees to rotational movement y.

When the engine 11 of the powering device 10 is started, the user can cause the power shaft 21 to rotate via the controls on the control panel 17. The rotational movement x of the power shaft 21 is transferred to the attachment shaft 24. The power transfer unit 32 transfers the rotational movement x by 90 degrees to rotational movement y, thereby rotating the soil tiller blades 71 about the soil tiller axle 72. In addition, the powering device 10 is capable of powering the wheels 14.

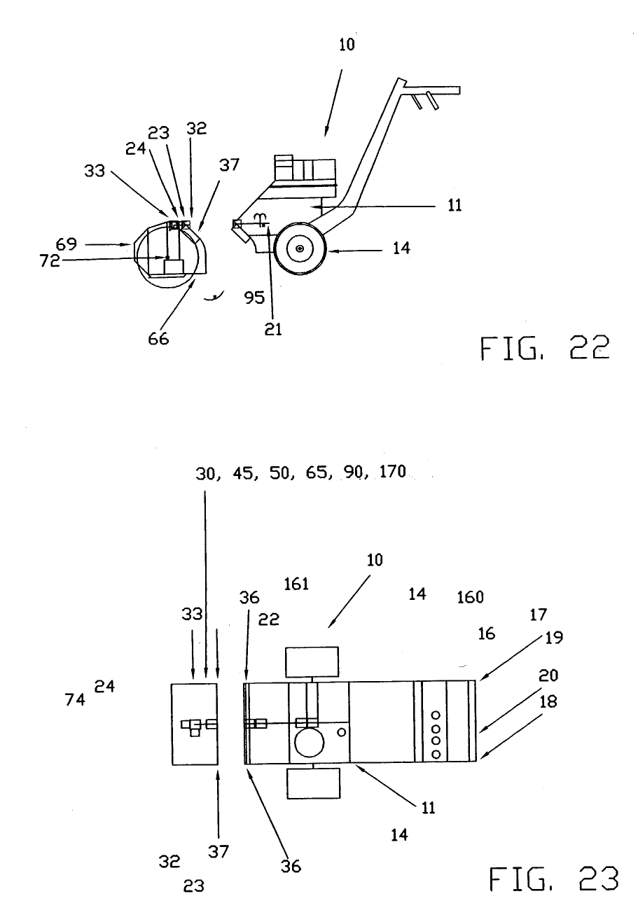

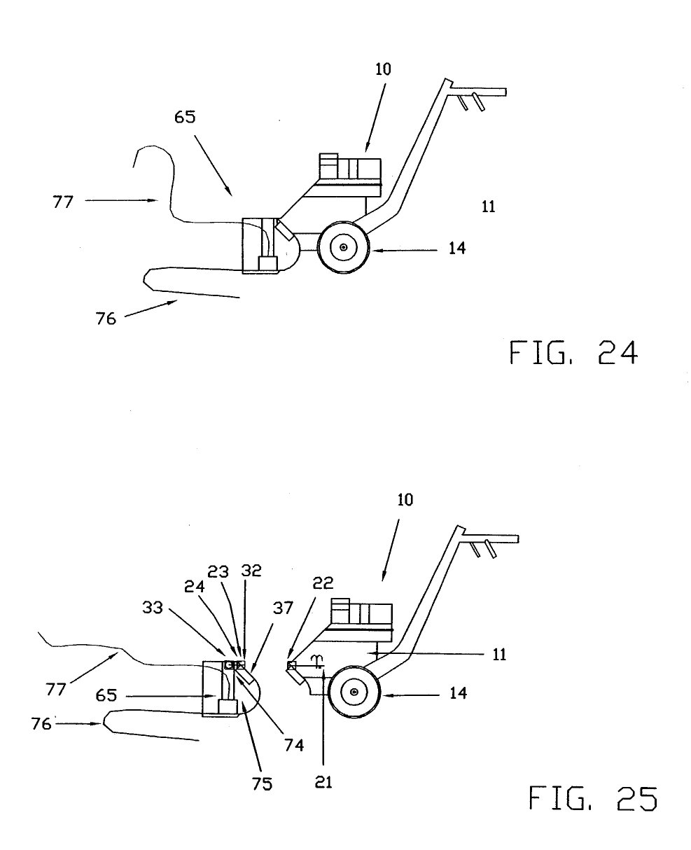

FIGS. 23-25 show the powering device 10 attached to the interchangeable working attachment called the pump 65. The pump 65 is operatively connected to the powering device 10. Specifically, the coupling 22 of the power shaft 21 is rotatably connected to the mating connector 23 of the attachment shaft 24 of the pump 65. The rotational directions of the power shaft 21 and the attachment shaft 24 are shown as x. Because the rotational direction x needs to be transferred 90 degrees to an alternator axle 73, the power transfer unit 32 is operatively connected between the attachment shaft 24 and alternator axle 73. The power transfer unit 32 transfers the rotational movement x by 90 degrees to rotate the alternator axle 73. The power transfer unit 32 is preferably two 45 degree bevel gears 74 and the alternator axle 73. An alternative embodiment includes a gearbox for transferring rotational movement x by 90 degrees. The pump 65 is connected to an incoming pump hose 76 for drawing liquid into the pump 65 and a exiting pump hose 77 for releasing the liquid drawn into the pump 65 via the incoming pump hose 76.

The powering device 10 has a driving connection to, for example, the pump 65 via a power take off. This driving connection includes male connectors 22 and female receiver connectors 23. FIGS. 4-6 show one type of male connectors 22 and female receiver connectors 23. There are various types of connectors, known to those skilled in the art, that could be substituted for the male and female receiver connectors to transfer the power.

When the engine 11 of the powering device 10 is started, the user can cause the power shaft 21 to rotate via the controls on the control panel 17. The rotational movement x of the power shaft 21 is transferred to the attachment shaft 24. The power transfer unit 32 transfers the rotational movement x by 90 degrees, thereby rotating the alternator axle 73 of the pump 65. In addition, the powering device 10 is capable of powering the wheels 14.

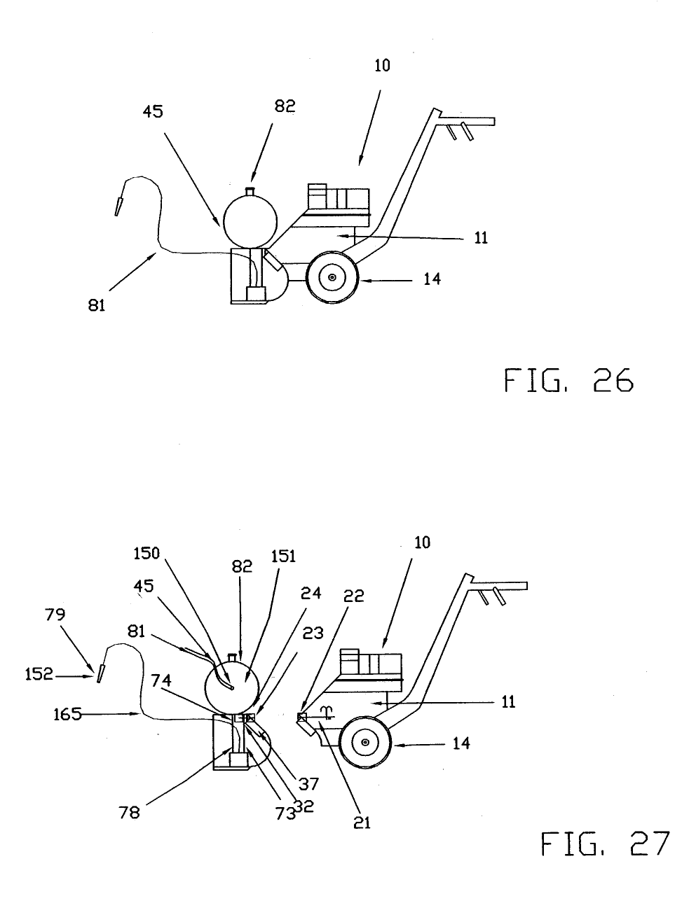

FIGS. 23, 26 and 27 show the powering device 10 attached to the interchangeable working attachment called the power washer/garden sprayer 45. The power washer/garden sprayer 45 is operatively connected to the powering device 10. The powering device 10 transfers power to the power washer/garden sprayer pump 78 of the power washer/garden sprayer 45. Specifically, the coupling 22 of the power shaft 21 is rotatably connected to the mating connector 23 of the attachment shaft 24 of the power washer/garden sprayer 45. The rotational directions of the power shaft 21 and the attachment shaft 24 are shown as x. Because the rotational direction x needs to be transferred 90 degrees to the alternator axle 73 of the power washer/garden sprayer 45, the power transfer unit 32 is operatively connected between the attachment shaft 24 and the alternator axle 73. The power transfer unit 32 transfers the rotational movement x by 90 degrees to rotate the alternator axle 73. The power transfer unit 32 is preferably the two 45 degree bevel gears 74 and the alternator axle 73. An alternative embodiment includes a gearbox for transferring rotational movement x by 90 degrees. The power washer/garden sprayer 45 has a water tank 82. The water tank 82 is pressurized by the power washer/garden sprayer pump 78. A water hose 81 is connected to the water tank 82. The water hose 81 can be a standard water hose. The water hose 81 is connected to the water tank 82 to provide an unlimited amount of water to the power washer/garden sprayer 45. The water hose 81 has a screw connector 150 removably connected to a thread connector 151 of the water tank 82. These connectors are typical of those on the garden hose and the water faucet. A sprayer hose 165 has a spray nozzle 79. The spray nozzle 152 has an on/off trigger and spray pattern adjuster.

The powering device 10 has a driving connection to, for example, the power washer/garden sprayer 45 via a power take off. This driving connection includes male connectors 22 and female receiver connectors 23. FIGS. 4-6 show one type of male connectors 22 and female receiver connectors 23. There are various types of connectors, known to those skilled in the art, that could be substituted for the male and female receiver connectors to transfer the power.

In an alternative embodiment, the power washer/garden sprayer pump 45 has a front wheel (not shown) and axle (not shown). Further, the power washer/garden sprayer pump 45 has a sprayer bar (not shown) attached to the water tank 82 via the water hose 81. In this embodiment, the powering device 10 and the power washer/garden sprayer pump 45 are used to water surfaces such as lawns and dirt roads. Fertilizers, pesticides and weed killer compounds can be substituted for water and applied to lawns.

When the engine 11 of the powering device 10 is started, the user can cause the power shaft 21 to rotate via the controls on the control panel 17. The rotational movement x of the power shaft 21 is transferred to the attachment shaft 24. The power transfer unit 32 transfers the rotational movement x by 90 degrees, thereby rotating the alternator axle 73 of the power washer/garden sprayer pump 78. The power washer/garden sprayer pump 78 pressurizes the water tank 82. The spray nozzle 79 is used to release the pressurized water from the water tank 82. The spray nozzle 79 is adjustable, so the water can be released at different pressures and spray volumes. In addition, the powering device 10 is capable of powering the wheels 14.

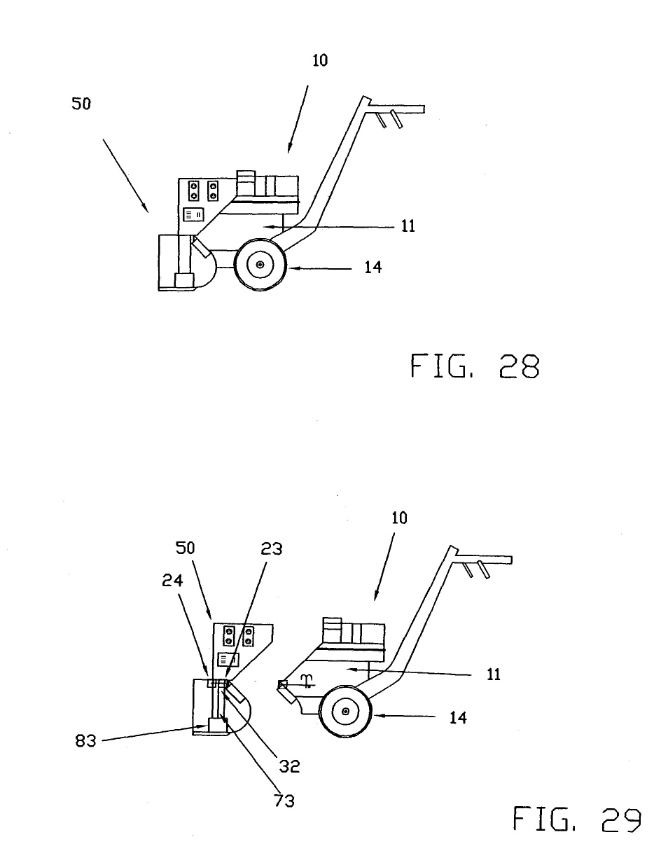

FIGS. 23, 28 and 29 show the powering device 10 attached to the interchangeable working attachment called the generator 50. The generator 50 is operatively connected to the powering device 10. The powering device 10 transfers power to the alternator 83 of the generator 50. Specifically, the coupling 22 of the power shaft 21 is rotatably connected to the mating connector 23 of the attachment shaft 24 of the generator 50. The rotational directions of the power shaft 21 and the attachment shaft 24 are shown as x. Because the rotational direction x needs to be transferred 90 degrees to the alternator axle 73 of the generator 50, the power transfer unit 32 is operatively connected between the attachment shaft 24 and the alternator axle 73. The power transfer unit 32 transfers the rotational movement x by 90 degrees to rotate the alternator axle 73. The power transfer unit 32 is preferably the two 45 degree bevel gears 74 and the alternator axle 73. An alternative embodiment includes a gearbox for transferring rotational movement x by 90 degrees.

The powering device 10 has a driving connection to, for example, the generator 50 via a power take off. This driving connection includes male connectors 22 and female receiver connectors 23. FIGS. 4-6 show one type of male connectors 22 and female receiver connectors 23. There are various types of connectors, known to those skilled in the art, that could be substituted for the male and female receiver connectors to transfer the power.

The generator 50 is exemplary of those attachments which can be transported from one location to another when mounted on the powering device 10. Simply stated, the powering device 10 is tilted towards yourself by pushing downwardly on the handles 18, 19 and lifting the generator or other attachment off the ground. The coupled attachment is then easily transported via the wheels 14 to move it to the new location. The lack of wheels on the attachment helps keep the attachment from moving or creeping due to engine vibrations while in use. Brakes could be added to the wheels but this unduly adds complexity. Other attachments which fall in this general category include the pump 65, the power washer/garden sprayer 45, the limb chipper mulcher 90 and air compressor 170.

When the engine 11 of the powering device 10 is started, the user can cause the power shaft 21 to rotate via the controls on the control panel 17. The rotational movement x of the power shaft 21 is transferred to the attachment shaft 24. The power transfer unit 32 transfers the rotational movement x by 90 degrees, thereby rotating the alternator axle 73 of the alternator 83. The generator 50 is used in much the same way as other generators. In addition, the powering device 10 is capable of powering the wheels 14.

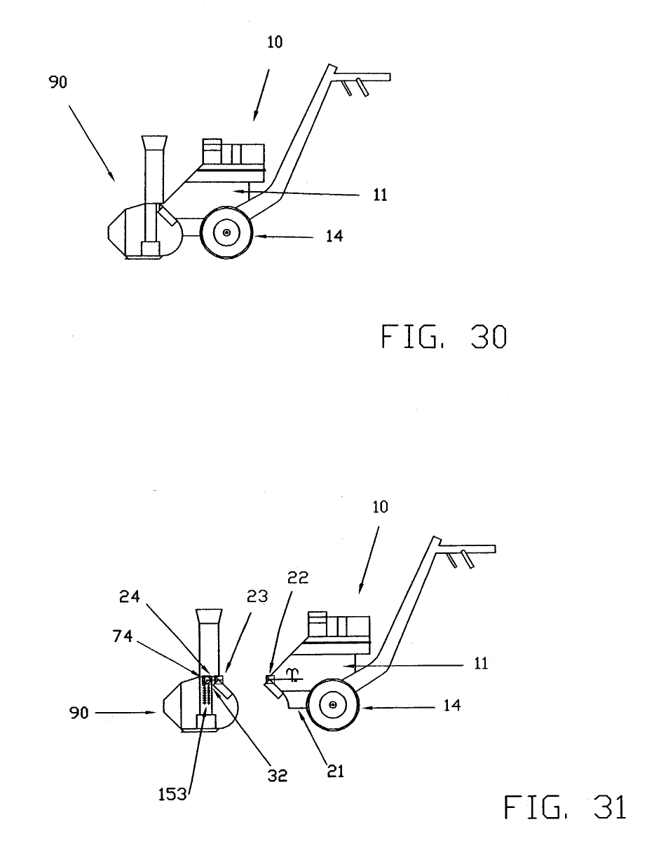

FIGS. 23, 30 and 31 show the powering device 10 attached to the interchangeable working attachment called the limb chipper mulcher 90. The limb chipper mulcher 90 is operatively connected to the powering device 10. The powering device 10 transfers power to cutting teeth 153 enclosed in a housing of the limb chipper 90. The cutting teeth 153 are enclosed in the housing are typical of cutter teeth used in stand alone mulcher/chippers, which are commonly available. Specifically, the coupling 22 of the power shaft 21 is rotatably connected to the mating connector 23 of the attachment shaft 24 of the limb chipper mulcher 90. The rotational directions of the power shaft 21 and the attachment shaft 24 are shown as x. Because the rotational direction x needs to be transferred 90 degrees, the power transfer unit 32 is operatively connected between the attachment shaft 24 and the cutter teeth 153. The power transfer unit 32 transfers the rotational movement x by 90 degrees. The power transfer unit 32 is preferably the two 45 degree bevel gears 74. An alternative embodiment includes a gearbox for transferring rotational movement x by 90 degrees.

The powering device 10 has a driving connection to, for example, the limb chipper mulcher 90 via a power take off. This driving connection includes male connectors 22 and female receiver connectors 23. FIGS. 4-6 show one type of male connectors 22 and female receiver connectors 23. There are various types of connectors, known to those skilled in the art, that could be substituted for the male and female receiver connectors to transfer the power.

When the engine 11 of the powering device 10 is started, the user can cause the power shaft 21 to rotate via the controls on the control panel 17. The rotational movement x of the power shaft 21 is transferred to the attachment shaft 24. The power transfer unit 32 transfers the rotational movement x by 90 degrees. The shaft 24 will connect to the two bevel gears 74, which will in turn be connected to two additional gears, which are connected to two rotary cutters turning in opposite directions. By connecting the cutters to opposite sides of the two bevel gears 74, the desired opposite directions of the cutting blades will be achieved. In addition, the powering device 10 is capable of powering the wheels 14.

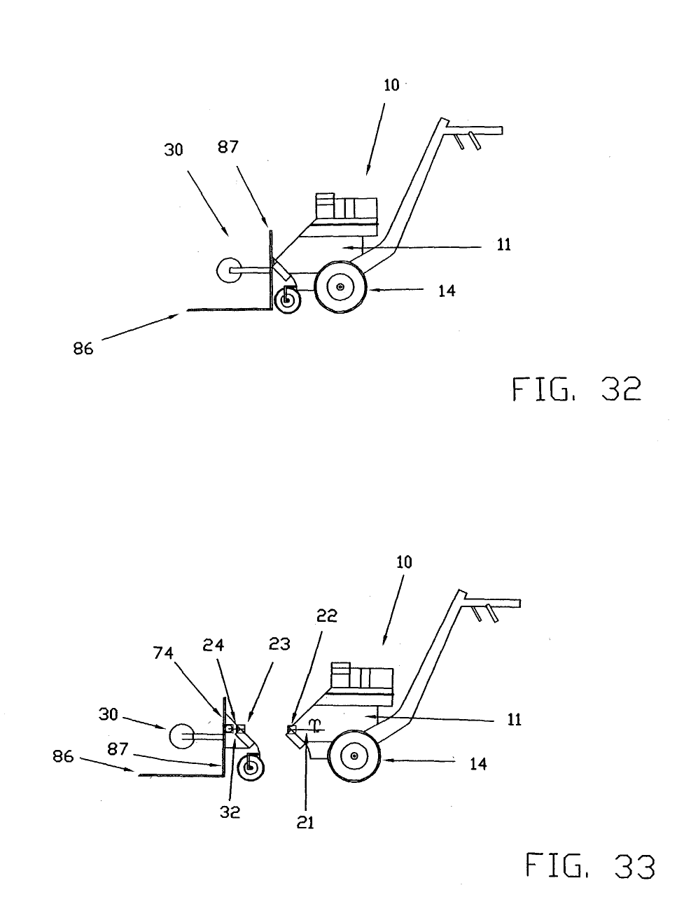

FIGS. 23, 32 and 33 show the powering device 10 attached to the interchangeable working attachment called the fork lift/garbage can holder 30. The fork lift/garbage can holder 30 is operatively connected to the powering device 10. The powering device 10 transfers power to the fork lift/garbage can holder 30. Specifically, the coupling 22 of the power shaft 21 is rotatably connected to the mating connector 23 of the attachment shaft 24 of the fork lift/garbage can holder 30. The rotational directions of the power shaft 21 and the attachment shaft 24 are shown as x. The shaft 24 is operatively connected to a hydraulic pump. The hydraulic pump pressurizes hydraulic oil providing the lift and/or grabbing action to raise and lower a platform 86. The hydraulic pump has a switch for controlling the forward and reverse movement of pressurized hydraulic oil, which would release grabber arms or lower the platform 84. These hydraulic pump are well known to those skilled in the art.

The powering device 10 has a driving connection to, for example, the fork lift/garbage can holder 30 via a power take off. This driving connection includes male connectors 22 and female receiver connectors 23. FIGS. 4-6 show one type of male connectors 22 and female receiver connectors 23. There are various types of connectors, known to those skilled in the art, that could be substituted for the male and female receiver connectors to transfer the power.

When the engine 11 of the powering device 10 is started, the user can cause the power shaft 21 to rotate via the controls on the control panel 17. The rotational movement x of the power shaft 21 is transferred to the attachment shaft 24. The power transfer unit 32 is preferably a hydraulic pump 74. The shaft 24 is operatively connected to the hydraulic pump 74. The hydraulic pump 74 pressurizes hydraulic oil providing the lift or grabbing action to raise and lower the platform 84. The hydraulic pump 74 has a switch for controlling the forward and reverse movement of pressurized hydraulic oil, which would release grabber arms 162 or lower the platform 84. The hydraulic pump 74 is well known to those skilled in the art. In addition, the powering device 10 is capable of powering the wheels 14.

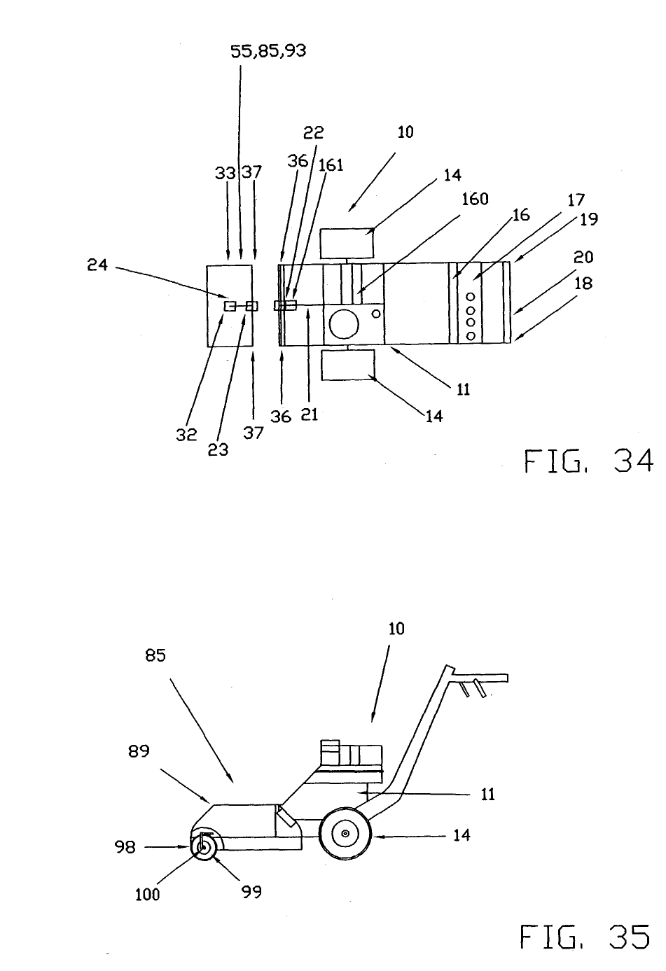

FIGS. 34-36 show the powering device 10 attached to the interchangeable working attachment called the grass mower 85. The grass mower 85 is operatively connected to the powering device 10. Specifically, the coupling 22 of the power shaft 21 is rotatably connected to the mating connector 23 of the attachment shaft 24 of the grass mower 85. The rotational directions of the power shaft 21 and the attachment shaft 24 are shown as x. Because the rotational direction x needs to be transferred 90 degrees downwardly to rotate mower blades 88 around a mower blade axle 84 as shown by rotational direction z, the power transfer unit 32 is operatively connected between the attachment shaft 24 and the mower blade axle 84. The mower blade axle 84 is rotatably attached to a mower hood 89. The power transfer unit 32 transfers the rotational movement x by 90 degrees to rotational movement z. The power transfer unit 32 is preferably the two 45 degree bevel gears 74 and the mower blade axle 84. An alternative embodiment includes a gearbox for transferring rotational movement x 90 degrees to rotational movement z.

The powering device 10 has a driving connection to, for example, the grass mower 85 via a power take off. This driving connection includes male connectors 22 and female receiver connectors 23. FIGS. 4-6 show one type of male connectors 22 and female receiver connectors 23. There are various types of connectors, known to those skilled in the art, that could be substituted for the male and female receiver connectors to transfer the power.

To support the grass mower 85, mower wheels 98 are rotatably connected to mower brackets 99 via mower wheel axles 100. The mower brackets 99 are connected to the mower hood 89.

When the engine 11 of the powering device 10 is started, the user can cause the power shaft 21 to rotate via the controls on the control panel 17. The rotational movement x of the power shaft 21 is transferred to the attachment shaft 24. The power transfer unit 32 transfers the rotational movement x by 90 degrees to rotational movement z, thereby rotating the mower blades 88 about the mower blade axle 84. In addition, the powering device 10 is capable of powering the wheels 14.

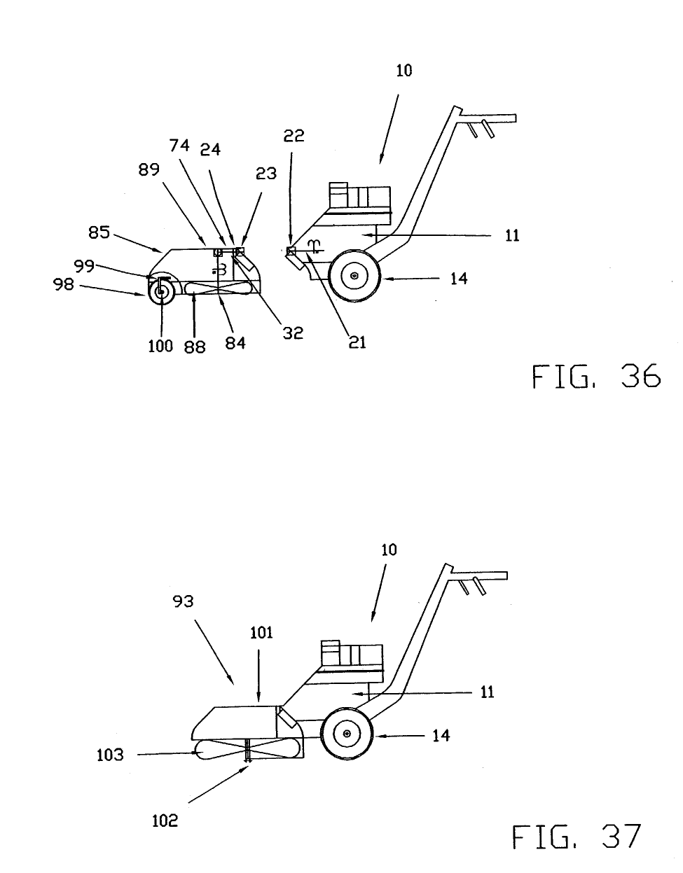

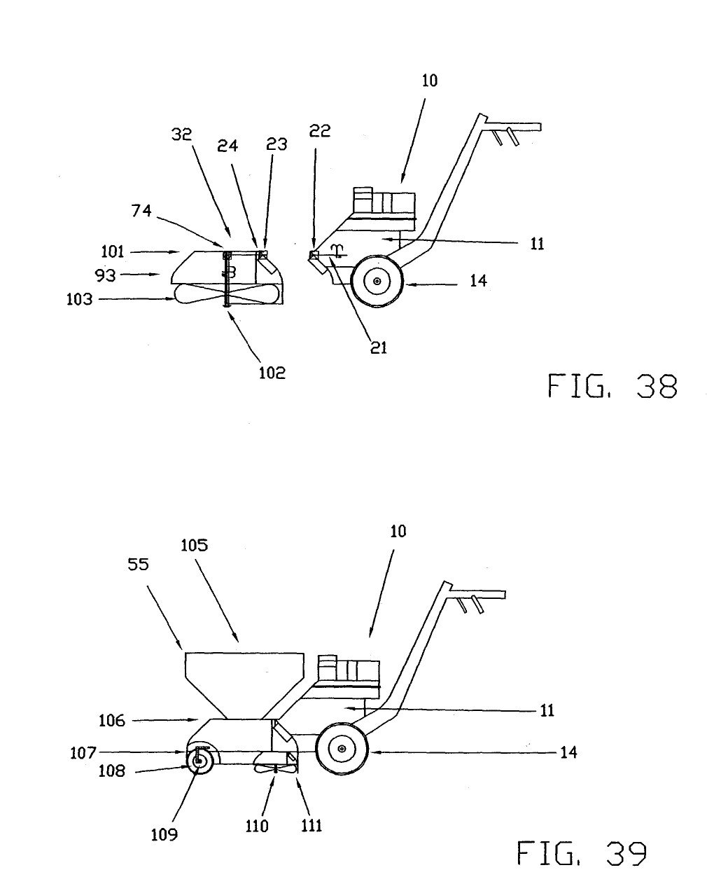

FIGS. 34, 37 and 38 show the powering device 10 attached to the interchangeable working attachment called the brush trimmer 93. The brush trimmer 93 is operatively connected to the powering device 10. Specifically, the coupling 22 of the power shaft 21 is rotatably connected to the mating connector 23 of the attachment shaft 24 of the brush trimmer 93. The rotational directions of the power shaft 21 and the attachment shaft 24 are shown as x. Because the rotational direction x needs to be transferred 90 degrees downwardly to rotate trimmer blades 103 around a trimmer axle 102 as shown by rotational direction z, the power transfer unit 32 is operatively connected between the attachment shaft 24 and the trimmer axle 102. The trimmer axle 102 is rotatably attached to a trimmer hood 101. The power transfer unit 32 transfers the rotational movement x by 90 degrees to rotational movement z. The power transfer unit 32 is preferably the two 45 degree bevel gears 74 and the trimmer axle 102. An alternative embodiment includes a gearbox for transferring rotational movement x 90 degrees to rotational movement z.

The powering device 10 has a driving connection to, for example, the brush trimmer 93 via a power take off. This driving connection includes male connectors 22 and female receiver connectors 23. FIGS. 4-6 show one type of male connectors 22 and female receiver connectors 23. There are various types of connectors, known to those skilled in the art, that could be substituted for the male and female receiver connectors to transfer the power.

When the engine 11 of the powering device 10 is started, the user can cause the power shaft 21 to rotate via the controls on the control panel 17. The rotational movement x of the power shaft 21 is transferred to the attachment shaft 24. The power transfer unit 32 transfers the rotational movement x by 90 degrees to rotational movement z, thereby rotating the trimmer blades 103 about the trimmer axle 102. In addition, the powering device 10 is capable of powering the wheels 14.

FIGS. 34, 39 and 40 show the powering device 10 attached to the interchangeable working attachment called the sweeper/vacuum 55. The sweeper/vacuum 55 is operatively connected to the powering device 10. Specifically, the coupling 22 of the power shaft 21 is rotatably connected to the mating connector 23 of the attachment shaft 24 of the sweeper/vacuum 55. The rotational directions of the power shaft 21 and the attachment shaft 24 are shown as x. Because the rotational direction x needs to be transferred 90 degrees downwardly to sweeper brushes 111 around a sweeper axle 110 as shown by rotational direction z, the power transfer unit 32 is operatively connected between the attachment shaft 24 and the sweeper axle 110. The sweeper axle 110 is rotatably attached to a sweeper/vacuum hood 106. The power transfer unit 32 transfers the rotational movement x by 90 degrees to rotational movement z. The power transfer unit 32 is preferably the two 45 degree bevel gears 74 and the sweeper axle 110. An alternative embodiment includes a gearbox for transferring rotational movement x 90 degrees to rotational movement z.

The powering device 10 has a driving connection to, for example, the sweeper/vacuum 55 via a power take off. This driving connection includes male connectors 22 and female receiver connectors 23. FIGS. 4-6 show one type of male connectors 22 and female receiver connectors 23. There are various types of connectors, known to those skilled in the art, that could be substituted for the male and female receiver connectors to transfer the power.

To support the sweeper/vacuum 55, sweeper/vacuum wheels 108 are rotatably connected to sweeper/vacuum brackets 107 via sweeper/vacuum wheel axles 109. The sweeper/vacuum brackets 107 are connected to the sweeper/vacuum hood 106. The sweeper/vacuum container 105 is operatively connected to the sweeper/vacuum hood 101 and is used to temporarily store vacuumed matter.

When the engine 11 of the powering device 10 is started, the user can cause the power shaft 21 to rotate via the controls on the control panel 17. The rotational movement x of the power shaft 21 is transferred to the attachment shaft 24. The power transfer unit 32 transfers the rotational movement x by 90 degrees to rotational movement z, thereby rotating the sweeper brushes 111 about the sweeper axle 110. The sweeper/vacuum 55 is moved along a surface and dirt, etc. is brushed and/or vacuumed into the sweeper/vacuum container 105. The vacuum is created by an air pump operatively attached between the power transfer unit 32 and sweeper axle 110. The air pump creates a suction, which would then draw air, dirt and other foreign matter to the sweeper/vacuum container 105. The vacuuming action is well known to those skilled in the art. Industrial and home vacuums operate in much the same way. By reversing the action via a sweeper/vacuum switch, the action switches from a vacuum to a sweeper. An air blower could be used, much like typical leaf blowers sold in stores. In addition, the powering device 10 is capable of powering the wheels 14.

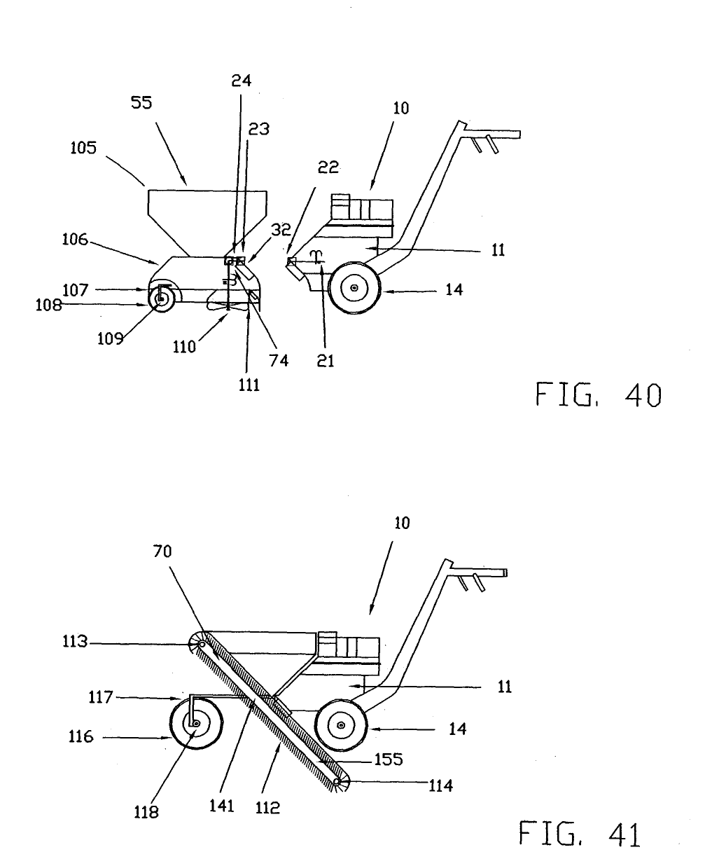

FIGS. 10, 41 and 42 show the powering device 10 attached to the interchangeable working attachment called the trencher 70. The trencher 70 is operatively connected to the powering device 10. The powering device 10 transfers power to the trencher 70. Specifically, the coupling 22 of the power shaft 21 is rotatably connected to the mating connector 23 of the attachment shaft 24 of the trencher 70. The rotational directions of the power shaft 21 and the attachment shaft 24 are shown as x. Because the rotational direction x needs to be transferred 90 degrees to rotate a trencher tool 112 around a first gear 113 and a second gear 114, the power transfer unit 32 is operatively connected between the attachment shaft 24 and the trencher tool 112, the first gear 113 and the second gear 114. The power transfer unit 32 transfers the rotational movement x by 90 degrees to rotate the trencher tool 112 around the first gear and the second gear 114. The power transfer unit 32 is preferably the two 45 degree bevel gears 74 to move the trencher tool 112 around the first gear 113 and the second gear 114. The trencher tool 112 has a trencher chain 155 to mesh with the gears. An alternative embodiment includes a gearbox for transferring rotational movement x by 90 degrees.

The powering device 10 has a driving connection to, for example, the trencher 70 via a power take off. This driving connection includes male connectors 22 and female receiver connectors 23. FIGS. 4-6 show one type of male connectors 22 and female receiver connectors 23. There are various types of connectors, known to those skilled in the art, that could be substituted for the male and female receiver connectors to transfer the power.

When the engine 11 of the powering device 10 is started, the user can cause the power shaft 21 to rotate via the controls on the control panel 17. The rotational movement x of the power shaft 21 is transferred to the attachment shaft 24. The power transfer unit 32 transfers the rotational movement x by 90 degrees, thereby rotating the trencher tool 112 around the first gear 113 and the second gear 114. The trencher tool 112 digs the ground at an area proximate the second gear 114. In addition, the powering device 10 is capable of powering the wheels 14. A depth adjustment 141 is provided for setting and adjusting the depth at which the trencher tool 112 penetrates the ground.

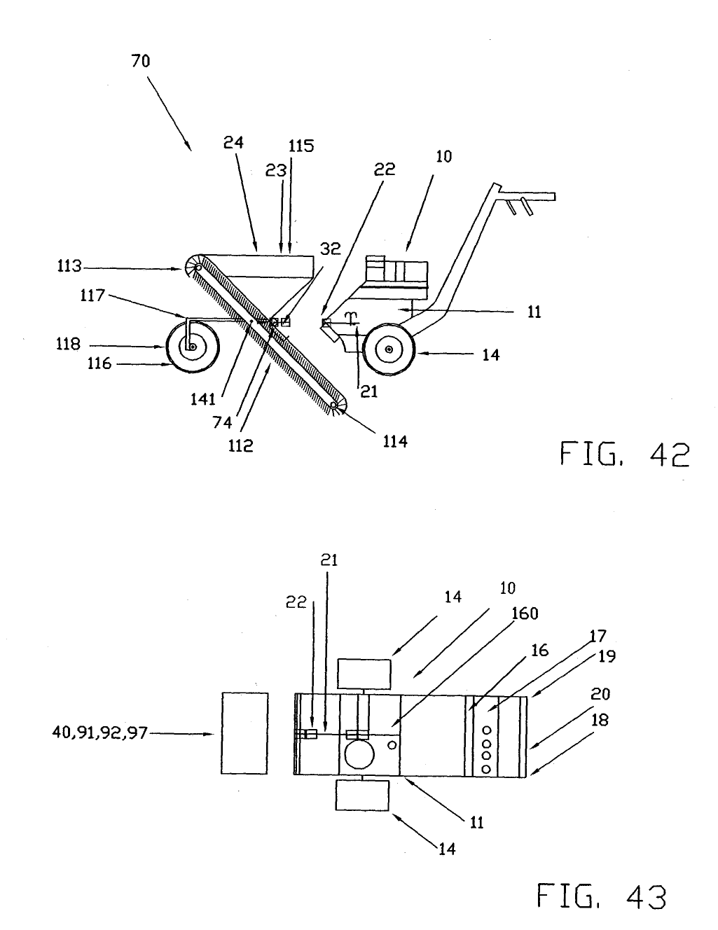

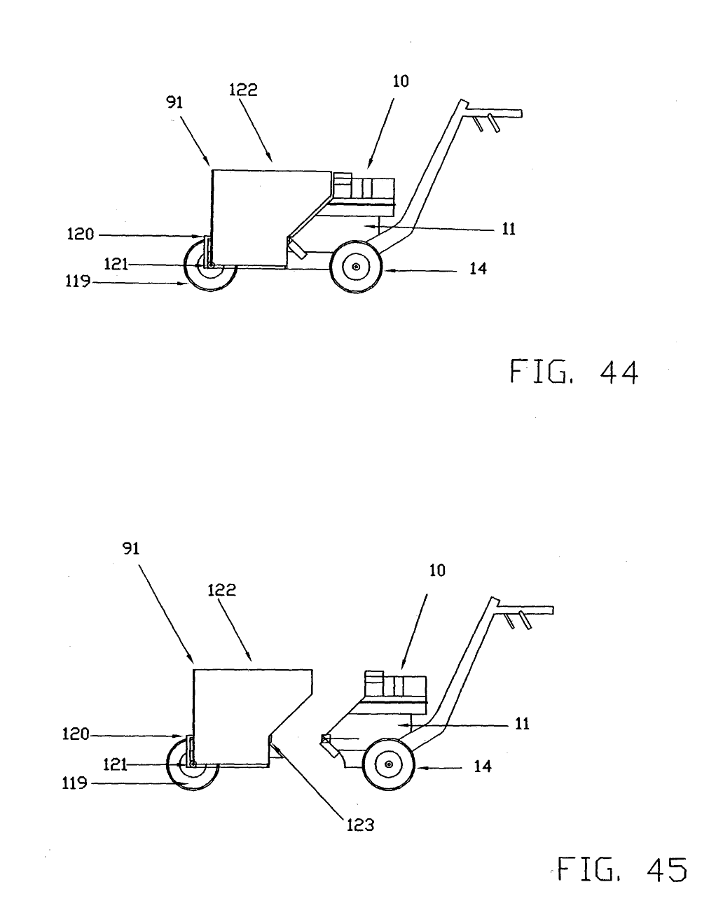

FIGS. 43-45 show the powering device 10 attached to the interchangeable working attachment called the dump hopper/soil sieve 91. The dump hopper/soil sieve 91 is operatively connected to the powering device 10. Specifically, the coupling 22 of the power shaft 21 is operatively connected to the mating connector 23 of the dump hopper/soil sieve 91. Unlike the previously disclosed embodiments, the mating connector 23 mounts to a ball bearing connector 123 and is able to rotate freely without transferring the rotational movement to a working component of the dump hopper/soil sieve 91. Because the powering device 10 rotates the power shaft 21 and the mating coupling 22, the ball bearing connector 123 is used to receive the matting connector 23; however, there is no transfer of this rotational movement to a working component of the dump hopper/soil sieve 91.

The powering device 10 has a driving connection to, for example, the dump hopper/soil sieve 91 via a power take off. This driving connection includes male connectors 22 and female receiver connectors 23. FIGS. 4-6 show one type of male connectors 22 and female receiver connectors 23. There are various types of connectors, known to those skilled in the art, that could be substituted for the male and female receiver connectors to transfer the power.

To support the hopper 91, hopper wheels 119 are rotatably connected to hopper brackets 120 via hopper axles 121. The edger brackets 120 are connected to a hopper container 122.

When the engine 11 of the powering device 10 is started, the user can cause the power shaft 21 to rotate via the controls on the control panel 17. The rotational movement of the power shaft 21 is transferred to the mating connector 23 and then to the ball bearing connector 123. In addition, the powering device 10 is capable of powering the wheels 14.

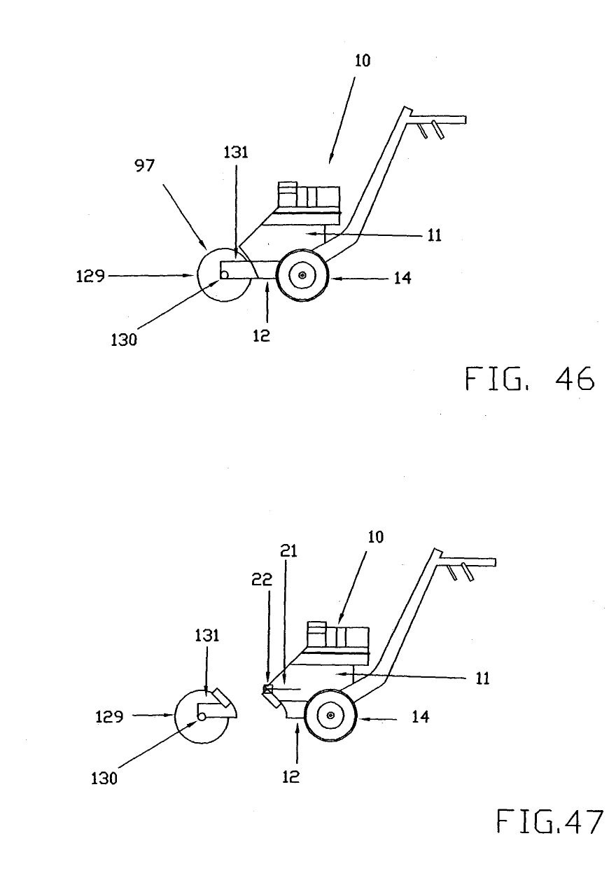

FIGS. 43, 46 and 47 show the powering device 10 attached to the interchangeable working attachment called the sod roller 97. The sod roller 97 is operatively connected to the powering device 10. Specifically, the coupling 22 of the power shaft 21 is operatively connected to the mating connector 23 of the sod roller 97. Unlike most of the previously disclosed embodiments, the mating connector 23 mounts to the ball bearing connector 123 and is able to rotate freely without transferring the rotational movement to a working component of the sod roller 97. Because the powering device 10 rotates the power shaft 21 and the mating coupling 22, the ball bearing connector 123 is used to receive the matting connector 23; however, there is no transfer of this rotational movement to a working component of the sod roller 97.

The powering device 10 has a driving connection to, for example, the sod roller 97 via a power take off. This driving connection includes male connectors 22 and female receiver connectors 23. FIGS. 4-6 show one type of male connectors 22 and female receiver connectors 23. There are various types of connectors, known to those skilled in the art, that could be substituted for the male and female receiver connectors to transfer the power.

To support the sod roller 97, a roller 129 is rotatably connected to a sod roller bracket 131 via a sod roller axle 130. The roller bracket 131 is operatively mounted to the frame 12 of the powering device 10. In alternative embodiments, the roller 129 is a hollow cylinder (not shown) that is rotatably connected to the sod roller bracket 131 via the sod roller axle 130. The hollow cylinder is not very heavy reducing shipping costs. In still another alternative embodiment, the roller 129 is a solid metal cylinder (not shown) that is rotatably connected to the sod roller bracket 131 via the sod roller axle 130.

When the engine 11 of the powering device 10 is started, the user can cause the power shaft 21 to rotate via the controls on the control panel 17. The rotational movement of the power shaft 21 is transferred to the ball bearing connector 123. In addition, the powering device 10 is capable of powering the wheels 14.

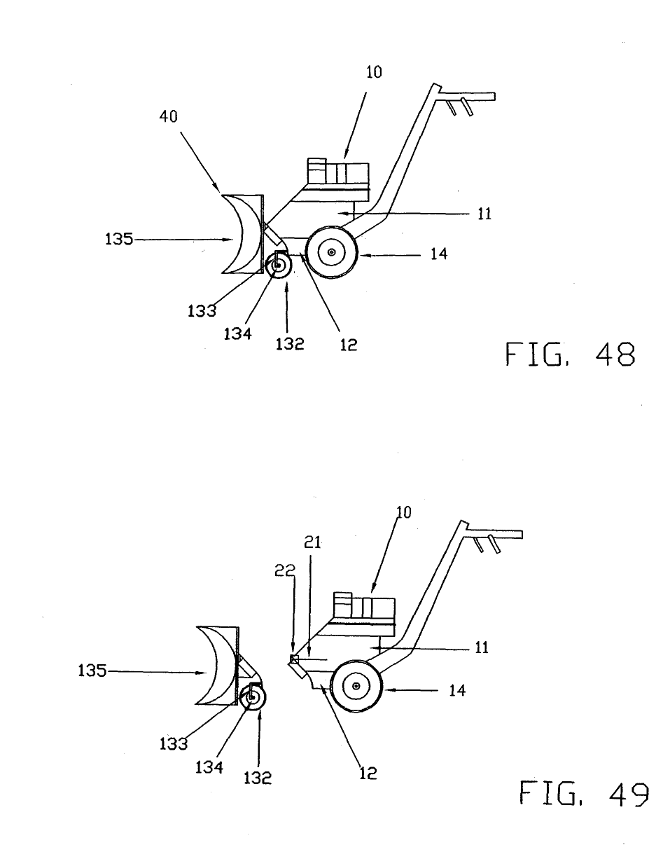

FIGS. 43, 48 and 49 show the powering device 10 attached to the interchangeable working attachment called the blade/plow 40. The blade/plow 40 is operatively connected to the powering device 10. Specifically, the coupling 22 of the power shaft 21 is operatively connected to the mating connector 23 of the blade/plow 40. Unlike most of the previously disclosed embodiments, the mating connector 23 mounts to the ball bearing connector 123 and is able to rotate freely without transferring the rotational movement to a working component of the blade/plow 40. Because the powering device 10 rotates the power shaft 21 and the mating coupling 22, the ball bearing connector 123 is used to receive the matting connector 23; however, there is no transfer of this rotational movement to a working component of the blade/plow 40.

The powering device 10 has a driving connection to, for example, the blade/plow 40 via a power take off. This driving connection includes male connectors 22 and female receiver connectors 23. FIGS. 4-6 show one type of male connectors 22 and female receiver connectors 23. There are various types of connectors, known to those skilled in the art, that could be substituted for the male and female receiver connectors to transfer the power.

To support the blade/plow 40, blade/plow wheels 132 are rotatably connected to blade/plow brackets 133 via blade/plow axles 134. The blade/plow brackets 133 are connected to the frame 12.

When the engine 11 of the powering device 10 is started, the user can cause the power shaft 21 to rotate via the controls on the control panel 17. The rotational movement of the power shaft 21 is transferred to the mating connector 23 and then to the ball bearing connector 123. In addition, the powering device 10 is capable of powering the wheels 14.

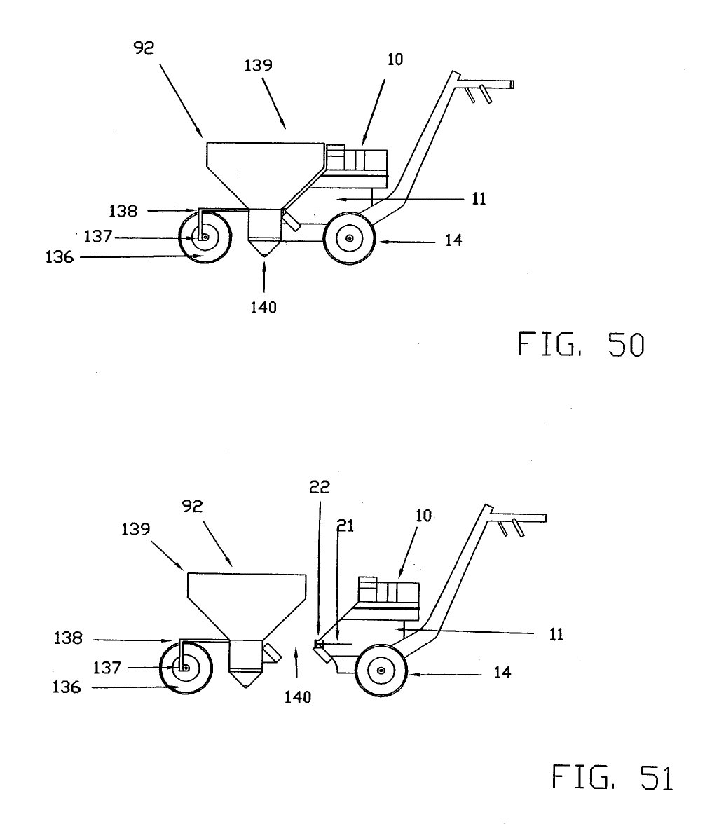

FIGS. 43, 50 and 51 show the powering device 10 attached to the interchangeable working attachment called the spreader 92. The spreader 92 is operatively connected to the powering device 10. Specifically, the coupling 22 of the power shaft 21 is operatively connected to the mating connector 23 of the spreader 92. Unlike most of the previously disclosed embodiments, the mating connector 23 mounts to the ball bearing connector 123 and is able to rotate freely without transferring the rotational movement to a working component of the spreader 92. Because the powering device 10 rotates the power shaft 21 and the mating coupling 22, the ball bearing connector 123 is used to receive the matting connector 23; however, there is no transfer of this rotational movement to a working component of the spreader 92.

The powering device 10 has a driving connection to, for example, the spreader 92 via a power take off. This driving connection includes male connectors 22 and female receiver connectors 23. FIGS. 4-6 show one type of male connectors 22 and female receiver connectors 23. There are various types of connectors, known to those skilled in the art, that could be substituted for the male and female receiver connectors to transfer the power.

To support the spreader 92, spreader wheels 136 are rotatably connected to spreader brackets 138 via spreader axles 137. The spreader brackets 138 are connected to a spreader hopper 139. The spreader 92 works in the typical way that most spreaders operate. The spreader wheels 136 generate transfers movement to a working part of the spreader 92. The spreader hopper 139 holds spreader materials.

When the engine 11 of the powering device 10 is started, the user can cause the power shaft 21 to rotate via the controls on the control panel 17. The rotational movement of the power shaft 21 is transferred to the mating connector 23 and then to the ball bearing connector 123. In addition, the powering device 10 is capable of powering the wheels 14.

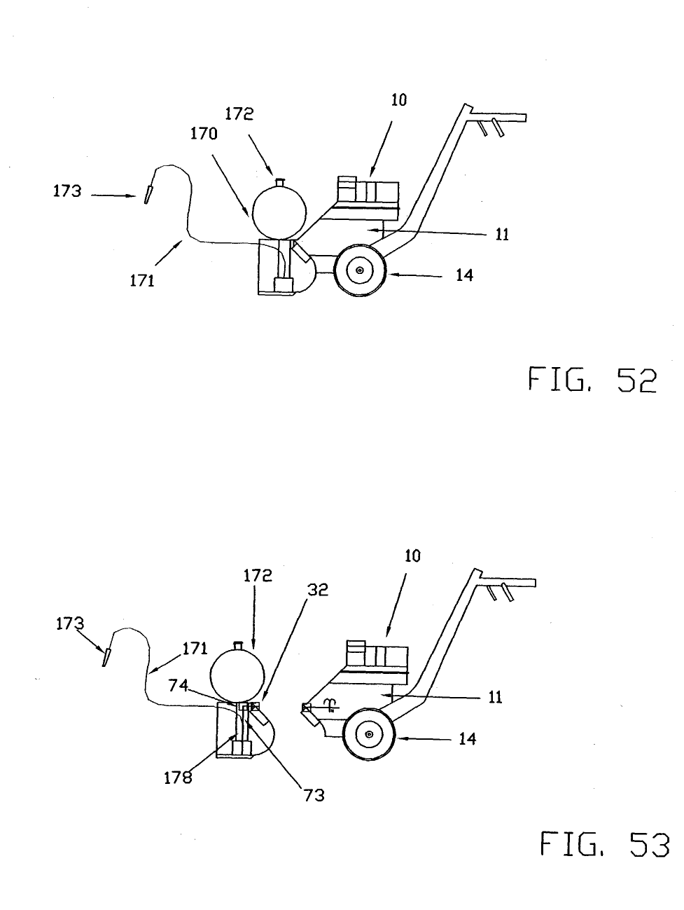

FIGS. 23, 52 and 53 show the powering device 10 attached to the interchangeable working attachment called the air compressor 170. The power air compressor 170 is operatively connected to the powering device 10. The powering device 10 transfers power to the air compressor pump 178 of the air compressor 170. Specifically, the coupling 22 of the power shaft 21 is rotatably connected to the mating connector 23 of the attachment shaft 24 of the air compressor 170. The rotational directions of the power shaft 21 and the attachment shaft 24 are shown as x. Because the rotational direction x needs to be transferred 90 degrees to the alternator axle 73 of the air compressor 170, the power transfer unit 32 is operatively connected between the attachment shaft 24 and the alternator axle 73. The power transfer unit 32 transfers the rotational movement x by 90 degrees to rotate the alternator axle 73. The power transfer unit 32 is preferably the two 45 degree bevel gears 74 and the alternator axle 73. An alternative embodiment includes a gearbox for transferring rotational movement x by 90 degrees. The air compressor 170 has an air tank 172. The air tank 172 is pressurized by compressed air. An air hose 171 has an air nozzle 173. The air nozzle 173 has an on/off trigger.

The powering device 10 has a driving connection to, for example, the air compressor 170 via a power take off. This driving connection includes male connectors 22 and female receiver connectors 23. FIGS. 4-6 show one type of male connectors 22 and female receiver connectors 23. There are various types of connectors, known to those skilled in the art, that could be substituted for the male and female receiver connectors to transfer the power.

When the engine 11 of the powering device 10 is started, the user can cause the power shaft 21 to rotate via the controls on the control panel 17. The rotational movement x of the power shaft 21 is transferred to the attachment shaft 24. The power transfer unit 32 transfers the rotational movement x by 90 degrees, thereby rotating the alternator axle 73 of the air compressor pump 178. The air compressor pump 178 pressurizes the air tank 172. The air nozzle 173 is used to release the pressurized air from the air tank 172. The air nozzle 173 can be connected to pneumatic tools such as an air nailer, spray paint equipment and tire pumps. In addition, the powering device 10 is capable of powering the wheels 14.

The powering device 10 and the attachments shown in FIGS. 7A and 7B are called “YARD MAX™” by the applicant.

Other objects, features and advantages of the present invention will be apparent to those skilled in the art. While preferred embodiments of the present invention have been illustrated and described, this has been by way of illustration and the invention should not be limited.

What is claimed is:

1. A powered, walk-behind machine including a power unit having a power-take-off and adaptable for powering a selected one of a plurality of interchangeable attachments each capable of performing a different function, at least one of the plurality of interchangeable attachments having a driven working member;
the power unit having an axle and a set of laterally spaced wheels rotatably mounted on the axle; a shaft having a driven connection to the power-take-off; a power source operatively connected to the shaft to drive the shaft; means for mounting the power-take-off in a generally horizontal position extending to a front of the power unit and generally perpendicular to the axle; a manually operable handle at a rear of the power unit; the aforesaid components being so constructed and arranged that a center of gravity of the unit is adjacent the axle but not rearward thereof;
said one of the interchangeable attachments including a rotatable connector for connecting to the power-take-off; means for providing a driving connection between the working member and the rotatable connector; means for detachably mounting the selected interchangeable attachment to the power unit and supporting the selected interchangeable attachment on the power unit during operation; and
another of the interchangeable attachments having means for detachably mounting the other interchangeable attachment to the power unit and supporting the other interchangeable attachment on the power unit during operation;
whereby the interchangeable attachments may be selectively mounted on the power unit for performing the different function of each.

2. The powered, walk-behind machine according to claim 1, wherein the rotatable connector and the power-take-off have mating parts providing a rotational driving connection therebetween; and
wherein the means for providing a driving connection between the working member and the rotatable connector includes means for transferring the rotational movement of the rotatable connector by 90 degrees to deliver power to the working member.

3. The powered, walk-behind machine according to claim 2, wherein 10 the 90 degrees is in a generally horizontal plane.

4. The powered, walk-behind machine according to claim 3, wherein said one of the interchangeable attachments is selected from the group consisting of a snow blower attachment, lawn dethatcher power rake attachment, edger attachment, soil aerator attachment, sod cutter attachment, pavement cutter attachment, soil tiller attachment and trencher attachment.

5. The powered, walk-behind machine according to claim 2, wherein the 90 degrees is in a generally vertical plane.

6. The powered, walk-behind machine according to claim 3, wherein the selected working attachment is selected from the group consisting of a pump attachment, power washer attachment, generator attachment, chipper attachment, lift attachment and air compressor attachment.

7. The powered, walk-behind machine according to claim 2, wherein the 90 degrees is in a generally vertical plane.

8. The powered, walk-behind machine according to claim 3, wherein the selected working attachment is selected from the group consisting of a sweeper/vacuum, grass mower and brush trimmer.

9. A powered, walk-behind machine including a power unit having a power-take-off and adaptable for powering a plurality of interchangeable powered attachments, the power unit having:
an axle and a set of laterally spaced wheels rotatably mounted on the axle;
a shaft having a driven connection to the power-take-off;
a gasoline engine operatively connected to the shaft to drive the shaft;
means for mounting the power-take-off so that it is generally horizontal and extending to a front of the power unit;
the power-take-off being arranged generally perpendicular to the axle;
a manually operable handle at a rear of the power unit;
the aforesaid components being so constructed and arranged that a center of gravity of the unit is forward of the axle;
each of the plurality of powered attachments having a rotatable connector for connecting to the shaft of the power-take-off;
means for selecting one of the powered attachments;
means for clamping the selected powered attachments to the power unit and supporting the selected powered attachment on the power unit; and
whereby the selected powered attachment is selected for performing a certain function.

10. The powered, walk-behind machine according to claim 9, wherein the selected working attachment is selected from the group consisting of a snow blower attachment, lawn dethatcher power rake attachment, edger attachment, soil aerator attachment, sod cutter attachment, pavement cutter attachment, soil tiller attachment and trencher attachment.

11. The powered, walk-behind machine according to claim 9, wherein the selected working attachment is selected from the group consisting of a pump attachment, power washer attachment, generator attachment, chipper attachment, lift attachment and air compressor attachment.

12. The powered, walk-behind machine according to claim 9, wherein the selected working attachment is selected from the group consisting of a sweeper/vacuum, grass mower and brush trimmer.

13. The powered, walk-behind machine according to claim 9, wherein the selected working attachment is selected from the group consisting of a dump hopper/soil sieve, sod roller, blade/plow and spreader.

14. The powered, walk-behind machine according to claim 13, further comprising:
a rotatable shaft connector operatively attached to the shaft; and
means for precluding the transfer of the rotational movement of the rotatable shaft to the working attachment.

15. The powered, walk-behind machine according to claim 14; wherein the selected working attachment is the dump hopper/soil sieve attachment having a hopper container and a set of wheels rotatably mounted to the dump hopper/soil sieve via a hopper axle.

16. The powered, walk-behind machine according to claim 14, wherein the selected working attachment is the sod roller attachment having a rotatably mounted roller.

17. The powered, walk-behind machine according to claim 14, wherein the selected working attachment is the blade/plow attachment having a plow and a set of wheels for supporting the blade/plow attachment.

18. The powered, walk-behind machine according to claim 14, wherein the selected working attachment is the spreader attachment having a spreader hopper and spreader wheels, wherein the spreader hopper holds spreading materials and the spreader wheels support the spreader attachment.
